(19) United States
(12) Patent Application Publication
(10) Pub. No.: US 2025/0283307 A1
(43) Pub. Date: Sep. 11, 2025

(54) WORK MACHINE AND CONTROL SYSTEM FOR WORK MACHINE

(71) Applicant: SUMITOMO CONSTRUCTION MACHINERY CO., LTD., Tokyo (JP)

(72) Inventors: Yuiki MATSUHASHI, Chiba (JP); Kazuma SHINKAI, Chiba (JP)

(21) Appl. No.: 19/072,336

(22) Filed: Mar. 6, 2025

(30) Foreign Application Priority Data
Mar. 11, 2024 (JP) 2024-037498

(51) Int. Cl. E02F 9/26; E02F 9/16; H04R 3/00

(52) U.S. Cl. CPC E02F 9/262; E02F 9/16; H04R 3/002; H04R 2400/01; H04R 2499/13

(57) ABSTRACT

A work machine includes a lower traveling body; an upper turning body mounted on the lower traveling body so as to freely turn; a driving room provided in the upper turning body; an external sound collecting device arranged outside the driving room; an internal sound output device arranged inside the driving room; and a control device configured to limit output, from the internal sound output device, of sound collected by the external sound collecting device, according to a detection result of an object existing around the work machine.

### CROSS-REFERENCE TO RELATED APPLICATION

The present application is based on and claims priority under 35 U.S.C. § 119 to Japanese Patent Application No. 2024-037498, filed on Mar. 11, 2024, the contents of which are incorporated herein by reference in their entirety.

### BACKGROUND

### Technical Field

The present invention relates to a work machine and a control system for the work machine.

### Description of Related Art

In the related art, a work machine may be provided with a sound collecting device for collecting sound around the work machine and a speaker for outputting the collected sound to the driving seat of the work machine. Thus, an operator can recognize the situation around the work machine by sound.

### SUMMARY

According to an embodiment of the present invention, there is provided a work machine including a lower traveling body; an upper turning body mounted on the lower traveling body so as to freely turn; a driving room provided in the upper turning body; an external sound collecting device arranged outside the driving room; an internal sound output device arranged inside the driving room; and a control device configured to limit output, from the internal sound output device, of sound collected by the external sound collecting device, according to a detection result of an object existing around the work machine.

### BRIEF DESCRIPTION OF THE DRAWINGS

FIG. 1 is a side view of a work machine according to an embodiment of the present disclosure;

FIG. 2 is a top view of a work machine illustrated in FIG. 1;

FIG. 3 is a diagram illustrating an example of the configuration of an external sound collecting device and an information transmission device attached to the work machine illustrated in FIG. 1;

FIG. 4 is a diagram schematically illustrating an example of the configuration of the work machine illustrated in FIG. 1;

FIG. 5 is a top view of the inside of the driving room illustrated in FIG. 1;

FIG. 6 is a perspective view of the work machine in which an operator is seated and a worker around the work machine;

FIG. 7 is an explanatory diagram illustrating limitation of sound in the work machine according to an embodiment;

FIG. 8 is a flowchart illustrating a processing procedure for limiting the output of sound according to the operating sound emitted by the object in the controller according to an embodiment;

FIG. 9 is an explanatory diagram illustrating control between the work machine according to another embodiment and another work machine;

FIG. 10 is a sequence diagram illustrating control performed between the work machine according to another embodiment and another work machine;

FIG. 11 is a sequence diagram illustrating control performed between the work machine according to further another embodiment and another work machine;

FIG. 12 is a top view of another configuration example of a work machine according to further another embodiment; and

FIG. 13 is a schematic view illustrating a configuration example of an operation system according to further another embodiment.

### DETAILED DESCRIPTION

However, when an object around a work machine emits noise such as an operating sound, the operating sound is output to the driving seat, and there is a possibility that the quietness around the driving seat is reduced.

According to an embodiment of the present invention, quietness is improved by limiting the output of sound.

Embodiments of the present disclosure will be described below with reference to the drawings. The embodiments described below are exemplary rather than limiting the present invention. All features and combinations thereof described in the embodiments of the present disclosure are not necessarily essential to the present invention. In each of the drawings, the same or corresponding configurations are denoted by the same or corresponding reference numerals, and overlapping explanations may be omitted in some cases.

The work machine 100 according to the embodiment of the present disclosure is an excavator. The work machine 100 may be a machine other than an excavator such as a crane, an asphalt finisher, or a forklift. In the illustrated example, the excavator serving as the work machine 100 is an excavator provided with a bucket 6 as an end attachment, but it may be an application machine such as a forestry machine provided with an end attachment other than the bucket 6.

### First Embodiment

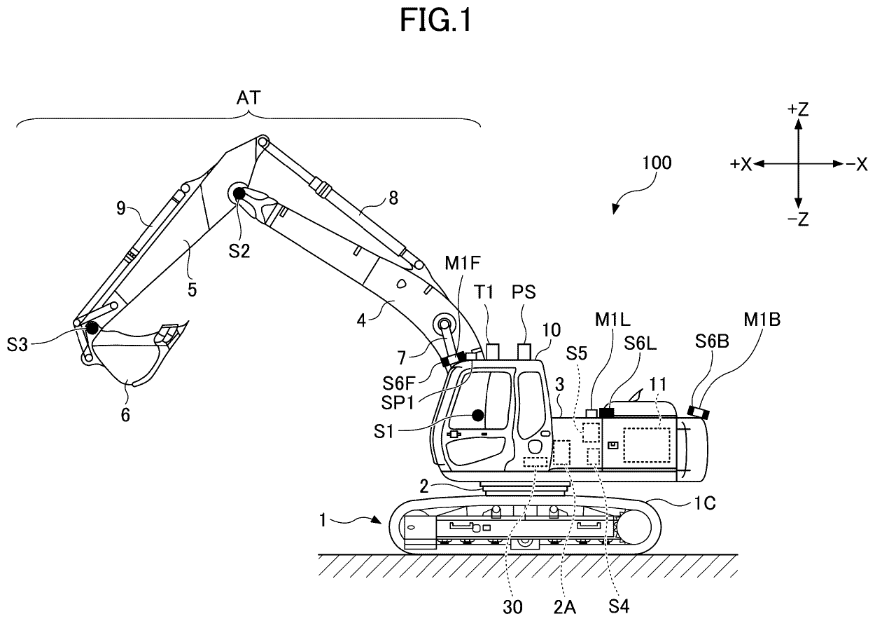

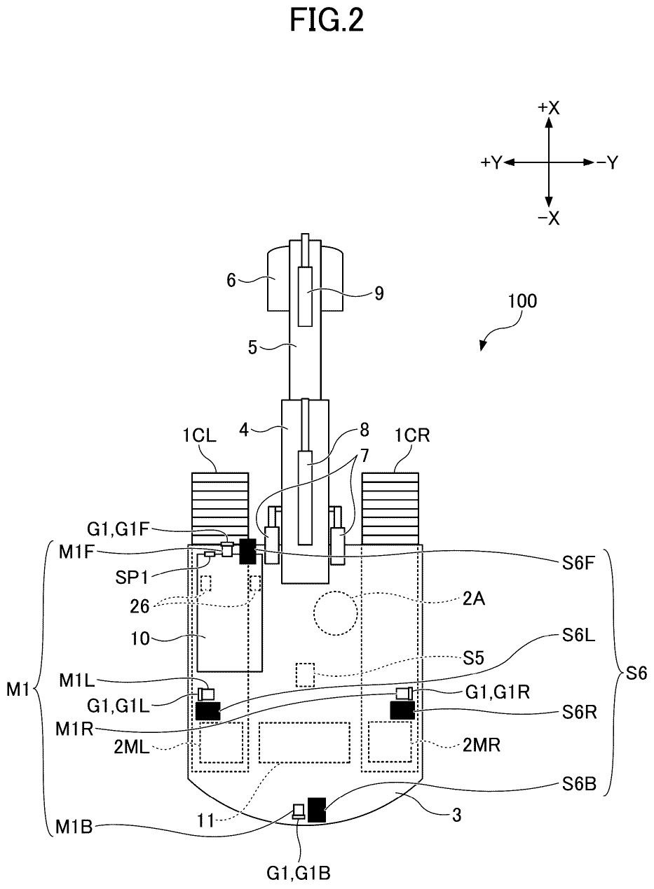

First, an outline of the work machine 100 will be described with reference to FIGS. 1 and 2. FIG. 1 is a side view of the work machine 100, and FIG. 2 is a top view of the work machine 100.

In FIG. 1, +X represents one direction of the X axis constituting the three-dimensional orthogonal coordinate system, and −X represents the other direction of the X axis. In FIG. 2, +Y represents one direction of the Y axis constituting the three-dimensional orthogonal coordinate system, and −Y represents the other direction of the Y axis. In FIG. 1, +Z represents one direction of the Z axis constituting the three-dimensional orthogonal coordinate system, and −Z represents the other direction of the Z axis. In FIG. 1, the +X side of the work machine 100 corresponds to the front side of the work machine 100, and the −X side of the work machine 100 corresponds to the rear side of the work machine 100. The +Y side of the work machine 100 corresponds to the left side of the work machine 100, and the −Y side of the work machine 100 corresponds to the right side of the work machine 100. The +Z side of the work machine 100 corresponds to the upper side of the work machine 100, and the −Z side of the work machine 100 corresponds to the lower side of the work machine 100. The same applies to other figures.

The work machine 100 is provided with a lower traveling body 1, an upper turning body 3 mounted on the lower traveling body 1 so as to be able to turn freely through a turning mechanism 2, an attachment AT for performing various kinds of work, and a driving room 10. The driving room 10 is also referred to as a cabin or a cab. The front side of the work machine 100 (the upper turning body 3) corresponds to the side to which the attachment AT is attached to the upper turning body 3 when the work machine 100 is viewed from the top along the turning axis of the upper turning body 3. The left side, the right side, and the rear side of the work machine 100 (the upper turning body 3) correspond to the left side, the right side, and the rear side respectively, as viewed from the operator sitting on the driving seat in the driving room 10.

The lower traveling body 1 includes, for example, a pair of left and right crawlers 1C. Specifically, the crawlers 1C include a left crawler 1CL and a right crawler 1CR. The left crawler 1CL is driven by a left traveling hydraulic motor 2ML, and the right crawler 1CR is driven by a right traveling hydraulic motor 2MR. The left traveling hydraulic motor 2ML is a traveling driving part that drives the left crawler 1CL that is the driven part and can rotate the left crawler 1CL. The right traveling hydraulic motor 2MR is a traveling driving part that drives the right crawler 1CR that is the driven part and can rotate the right crawler 1CR. The traveling driving part may be an electric motor.

The upper turning body 3 turns with respect to the lower traveling body 1 when the turning mechanism 2 is driven by the turning hydraulic motor 2A. The turning hydraulic motor 2A is a turning driving part that drives the upper turning body 3 that is a driven part and can change the orientation of the upper turning body 3. The turning driving part may be an electric motor.

A boom 4 is rotatably attached to the front center of the upper turning body 3, an arm 5 is rotatably attached to the tip of the boom 4, and a bucket 6 is rotatably attached to the tip of the arm 5. In the illustrated example, the boom 4, the arm 5, and the bucket 6 constitute an excavation attachment which is an example of the attachment AT. The boom 4, the arm 5, and the bucket 6 are driven by a boom cylinder 7, an arm cylinder 8, and a bucket cylinder 9, respectively.

The bucket 6 is an example of a work tool (end attachment). The bucket 6 is used, for example, for excavation work. Other work tools may be attached to the tip of the arm 5 in place of the bucket 6 depending on the work content. Other work tools may be other types of buckets such as large buckets, slope buckets, and dredging buckets. The other work tools may be types of work tools other than a bucket, such as agitators, breakers, grapples, or lifting magnets.

The turning hydraulic motor 2A, the left traveling hydraulic motor 2ML, the right traveling hydraulic motor 2MR, the boom cylinder 7, the arm cylinder 8, and the bucket cylinder 9 are hydraulic actuators driven by hydraulic oil discharged from the hydraulic pump.

In the work machine 100, all or part of the driven parts such as the lower traveling body 1, the upper turning body 3, the boom 4, the arm 5, and the bucket 6 may be electrically driven. That is, the work machine 100 may be a hybrid excavator or an electric excavator in which all or part of the driven parts are driven by an electric actuator.

An information transmission device G1, an external sound collecting device M1, an imaging device S6, and an external sound output device SP1 are attached to the work machine 100.

The imaging device S6 is provided in the upper turning body 3 or the driving room 10, and captures the surrounding area of the work machine 100 and acquires image information representing the surrounding area of the work machine 100. In the illustrated example, the imaging device S6 includes a front camera S6F, a left camera S6L, a right camera S6R, and a rear camera S6B.

The front camera S6F is a camera for capturing an area in front of the work machine 100, and is mounted on the outside of the driving room 10, such as the roof of the driving room 10 or the side face of the boom 4. The front camera S6F may be mounted, for example, on the ceiling of the driving room 10, that is, inside of the driving room 10. The left camera S6L is a camera for capturing an area to the left of the work machine 100, the right camera S6R is a camera for capturing an area to the right of the work machine 100, and the rear camera S6B is a camera for capturing an area to the rear of the work machine 100. Specifically, the front camera S6F, the left camera S6L, the right camera S6R, and the rear camera S6B are all monocular wide-angle cameras equipped with imaging devices such as CCD or CMOS, and output the captured images to the display device D1. Information of the images captured by the imaging device S6 is taken into the controller 30.

In the illustrated example, the front camera S6F is mounted on the roof of the driving room 10, the left camera S6L is mounted on the left end of the upper surface of the upper turning body 3, the right camera S6R is mounted on the right end of the upper surface of the upper turning body 3, and the rear camera S6B is mounted on the rear end of the upper surface of the upper turning body 3.

The imaging device S6 may constitute an object detection device for detecting objects around the work machine 100. The object detection device may be constituted by a device other than a camera. For example, the object detection device may be a LiDAR. The LiDAR is a device that can measure the distance between a point group of 1 million or more points within the monitoring range and a LiDAR (laser source). The object detection device may be another device that can measure the distance to the object, such as a stereo camera, a distance image camera, or a millimeter-wave radar. When a millimeter-wave radar or the like is used as the object detection device, the object detection device may transmit a large number of signals (such as laser beams) toward the object and receive the reflected signals to derive the distance and direction of the object. Alternatively, the object detection device may be a combination of two or more types of devices. For example, the object detection device may be a combination of an imaging device and a LiDAR, a combination of an imaging device and a millimeter-wave radar, or a combination of an imaging device and a stereo camera.

The external sound collecting device M1 is a device that collects external sound and is also referred to as a microphone or a mic. In the illustrated example, the external sound collecting device M1 is provided in the upper turning body 3 or the driving room 10, and converts sound (air vibration) generated around the work machine 100 into mechanical vibration, and converts the mechanical vibration into electrical signals. Specifically, the external sound collecting device M1 includes a front microphone M1F, a left microphone M1L, a right microphone M1R, and a rear microphone M1B.

The front microphone M1F is a microphone that collects sound generated in front of the work machine 100, and is mounted on the outside of the driving room 10, such as the roof of the driving room 10 and the side surface of the boom 4. The front microphone M1F may be mounted, for example, on the ceiling of the driving room 10, that is, inside of the driving room 10. The left microphone M1L collects sound generated in the left side of the work machine 100, the right microphone M1R collects sound generated on the right side of the work machine 100, and the rear microphone M1B collects sound generated at the rear of the work machine 100. The electric signals generated by the front microphone M1F, the left microphone M1L, the right microphone M1R, and the rear microphone M1B are taken into the controller 30.

In the illustrated example, the front microphone M1F is mounted on the roof of the driving room 10, the left microphone M1L is mounted on the left end of the upper surface of the upper turning body 3, the right microphone M1R is mounted on the right end of the upper surface of the upper turning body 3, and the rear microphone M1B is mounted on the rear end of the upper surface of the upper turning body 3. Thus, the four external sound collecting devices M1 (the front microphone M1F, the left microphone M1L, the right microphone M1R, and the rear microphone M1B) are provided at different positions of the upper turning body 3. Therefore, the controller 30 can detect the direction that is toward the sound source based on the difference (for example, differences in volume) among the sounds collected by the four external sound collecting devices M1. When an array microphone is used as the external sound collecting device M1, the direction in which the sound source is located can be detected based on, for example, a phase shift or a difference in volume.

In the illustrated example, each of the four external sound collecting devices M1 and each of the four imaging devices S6 are arranged so as to correspond to each other. Specifically, the front microphone M1F is arranged so as to be adjacent to the front camera S6F, the left microphone M1L is arranged so as to be adjacent to the left camera S6L, the right microphone M1R is arranged so as to be adjacent to the right camera S6R, and the rear microphone M1B is arranged so as to be adjacent to the rear camera S6B.

The external sound output device SP1 outputs sound toward the surrounding area of the work machine 100. In the illustrated example, the external sound output device SP1 is a non-directional speaker and is configured so as to output sound uniformly in all directions. However, the external sound output device SP1 may be a directional speaker which outputs sound toward a particular direction such as the front.

The information transmission device G1 informs the outside of the work machine 100 of the state of the work machine 100. In the illustrated example, the information transmission device G1 is provided in the upper turning body 3 or the driving room 10, and is configured so as to be able to transmit the state of the work machine 100 to the worker around the work machine 100. Specifically, the information transmission device G1 is a light emitting device, and includes a front light bar G1F, a left light bar G1L, a right light bar G1R, and a rear light bar G1B.

The front light bar G1F is a light emitting device capable of visually transmitting information to the worker or the like in front of the work machine 100, and is attached to the outside of the driving room 10, such as the roof of the driving room 10 or the side of the boom 4. The front light bar G1F may be attached, for example, to the inside of the driving room 10, such as to the ceiling of the driving room 10. The left light bar G1L is a light emitting device capable of visually transmitting information to the worker or the like at the left side of the work machine 100, the right light bar G1R is a light emitting device capable of visually transmitting information to the worker or the like at the right side of the work machine 100, and the rear light bar G1B is a light emitting device capable of visually transmitting information to the worker or the like at the rear of the work machine 100. Each of the front light bar G1F, the left light bar G1L, the right light bar G1R, and the rear light bar G1B emits light in response to an electric signal from the controller 30. In the illustrated example, the light emitting device is an LED light, but other light emitting devices such as a halogen lamp may be used. The light emitting device is a multicolor light emitting type, but may be a monochromatic light emitting type.

In the illustrated example, the front light bar G1F is attached to the roof of the driving room 10, the left light bar G1L is attached to the left end of the upper surface of the upper turning body 3, the right light bar G1R is attached to the right end of the upper surface of the upper turning body 3, and the rear light bar G1B is attached to the rear end of the upper surface of the upper turning body 3. Thus, the four information transmission devices G1 (the front light bar G1F, the left light bar G1L, the right light bar G1R, and the rear light bar G1B) are provided at different positions of the upper turning body 3. Therefore, by operating each of the four information transmission devices G1 separately, the controller 30 can convey the state of the work machine 100 to the workers at the front, left, right, and rear areas of the work machine 100.

In the illustrated example, each of the four information transmission devices G1 and each of the four external sound collecting devices M1 are arranged so as to correspond to each other. Specifically, the front light bar G1F is arranged so as to be adjacent to the front microphone M1F, the left light bar G1L is arranged so as to be adjacent to the left microphone M1L, the right light bar G1R is arranged so as to be adjacent to the right microphone M1R, and the rear light bar G1B is arranged so as to be adjacent to the rear microphone M1B.

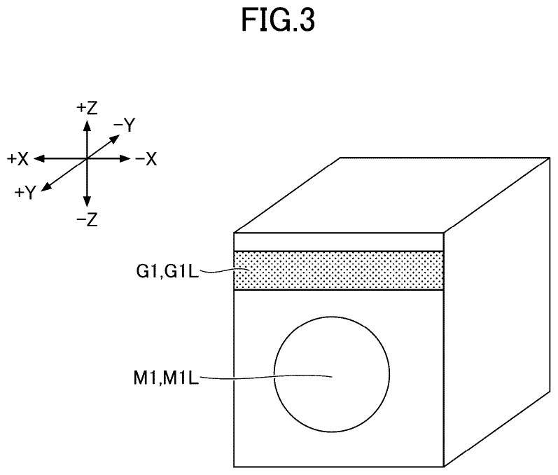

FIG. 3 is a diagram illustrating an example of the configuration of the external sound collecting device M1 and the information transmission device G1 attached to the work machine 100. Specifically, FIG. 3 is a perspective view of the left microphone M1L and the left light bar G1L attached to the substantially rectangular parallelepiped housing. Although the following description referring to FIG. 3 relates to the combination of the left microphone M1L and the left light bar G1L, the same applies to the combination of the front microphone M1F and the front light bar G1F, the combination of the right microphone M1R and the right light bar G1R, and the combination of the rear microphone M1B and the rear light bar G1B.

As illustrated in FIG. 3, the left microphone M1L and the left light bar G1L are arranged on the left side of the substantially rectangular parallelepiped housing so as to face the area to the left side of the work machine 100. With this arrangement, the left microphone M1L can efficiently collect sounds generated on the left side of the work machine 100, and the left light bar G1L can efficiently convey the state of the work machine 100 to the worker on the left side of the work machine 100. For example, the left microphone M1L can capture the voice spoken by the worker on the left side of the work machine 100, and the left light bar G1L can convey to the worker that the left microphone M1L has captured the voice of the worker by emitting light in a predetermined color. In this case, the worker on the left side of the work machine 100 who has spoken to the left microphone M1L can confirm that his or her voice has reached the left microphone M1L (i.e., the operator of the work machine 100) by seeing the left light bar G1L emitting light in a predetermined color.

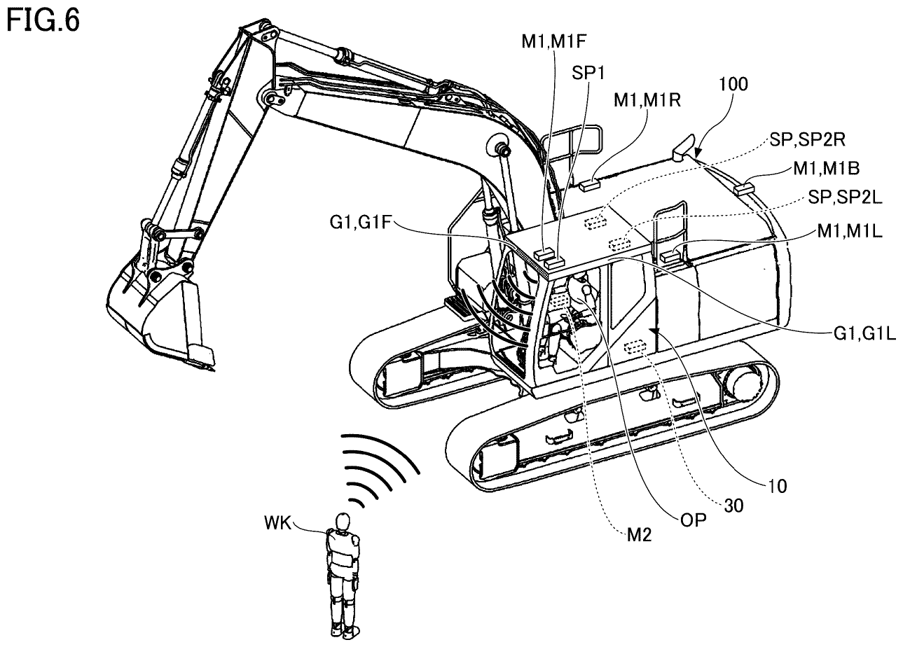

The information transmission device G1 may be provided at the top of each of the four sides of the driving room 10 (see FIG. 6). For example, the information transmission device G1 may be configured such that the front light bar G1F is attached to the top of the front face of the driving room 10, the left light bar G1L is attached to the top of the left face of the driving room 10, the right light bar G1R is attached to the top of the right face of the driving room 10, and the rear light bar G1B is attached to the top of the rear face of the driving room 10. Further, the information transmission device G1 may be a rotating lamp such as a NICO TORCH attached to the top of the driving room 10, or a display device such as a liquid crystal display or an organic EL display.

The controller 30 is an example of a control device and is composed of a computer including, for example, a CPU, a volatile storage device, a nonvolatile storage device, and various input/output interfaces. Then, the controller 30 implements various functions by, for example, reading a program from the nonvolatile storage device, loading the program into the volatile storage device, and causing the CPU to execute the program. In the illustrated example, the controller 30 is configured to implement various functions and control the work machine 100. The various functions include, for example, a machine guidance function for guiding the manual operation of the work machine 100 by an operator. The various functions may include a contact avoidance function for automatically or autonomously operating or stopping the work machine 100 in order to avoid contact between the work machine 100 and an object existing within the monitoring range around the work machine 100.

The boom angle sensor S1 detects the boom angle which is the rotation angle of the boom 4 with respect to the upper turning body 3. The arm angle sensor S2 detects the arm angle which is the rotation angle of the arm 5 with respect to the boom 4. The bucket angle sensor S3 detects the bucket angle which is the rotation angle of the bucket 6 with respect to the arm 5.

Each of the boom angle sensor S1, the arm angle sensor S2, and the bucket angle sensor S3 may be, for example, a rotary encoder, an acceleration sensor, a 6-axis sensor, an IMU (inertial measurement unit), etc., a potentiometer using a variable resistor, a cylinder stroke sensor for detecting the stroke amount of a hydraulic cylinder, etc.

A detection signal corresponding to the boom angle acquired by the boom angle sensor S1, a detection signal corresponding to the arm angle acquired by the arm angle sensor S2, and a detection signal corresponding to the bucket angle acquired by the bucket angle sensor S3 are taken into the controller 30.

The body inclination sensor S4 detects the inclined state of the body (the lower traveling body 1 or the upper turning body 3) with respect to the horizontal plane. The body inclination sensor S4 is attached to the upper turning body 3, for example, and detects the inclination angle of the work machine 100 (that is, the upper turning body 3) around two axes respectively in the longitudinal direction and the lateral direction. The body inclination sensor S4 may be, for example, an acceleration sensor, a 6-axis sensor, or an IMU. The detection signal corresponding to the inclination angle detected by the body inclination sensor S4 is taken into the controller 30.

The turning sensor S5 outputs information related to the turning of the upper turning body 3. The turning sensor S5 detects, for example, the turning angle speed of the upper turning body 3 relative to the lower traveling body 1. The turning sensor S5 may detect the turning angle. The turning sensor S5 may be, for example, a gyro sensor, a resolver, or a rotary encoder. A detection signal corresponding to the turning angle or turning angle speed of the upper turning body 3 detected by the turning sensor S5 is taken into the controller 30.

The positioning device PS measures the position of the upper turning body 3. The positioning device PS may be, for example, a GNSS (Global Navigation Satellite System) compass, and detects the position and orientation of the upper turning body 3. A detection signal corresponding to the position and orientation of the upper turning body 3 is taken into the controller 30. The function of detecting the orientation of the upper turning body 3 may be implemented by a direction sensor attached to the upper turning body 3.

The driving room 10 is a partitioned space where the operator is seated, and is provided on the front left side of the upper turning body 3. However, the driving room 10 may be omitted in a case where the work machine 100 is operated remotely or in a case where the work machine 100 is operated by fully automatic operation.

The communication device T1 communicates with external equipment through a communication network including a mobile communication network, a satellite communication network, or an Internet network. The communication device T1 may be, for example, a mobile communication module corresponding to a mobile communication standard such as LTE (Long Term Evolution), 4G (4th Generation), or 5G (5th Generation), etc., a communication module corresponding to a short range wireless communication standard such as Wi-Fi (registered trade mark) or Bluetooth (registered trade mark), or a satellite communication module for connecting to a satellite communication network.

The work machine 100 operates actuators in response to the operation of an operator seated in the driving room 10 to drive driven parts such as the lower traveling body 1, the upper turning body 3, the boom 4, the arm 5, and the bucket 6.

Alternatively, the work machine 100 may be configured to be remotely operated from the outside of the work machine 100. When the work machine 100 is remotely operated, the inside of the driving room 10 may be in an unmanned state.

Further, the work machine 100 may automatically operate the actuator regardless of the operation of the operator. Thus, the work machine 100 implements the function of automatically operating at least a part of the driven parts such as the lower traveling body 1, the upper turning body 3, the boom 4, the arm 5, and the bucket 6, that is, what is referred to as a “machine control function”.

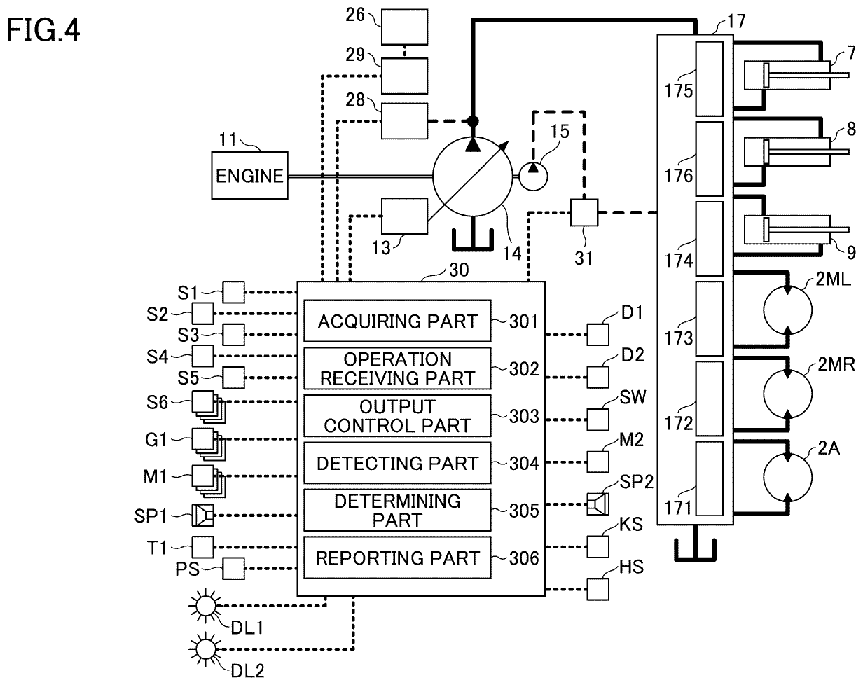

FIG. 4 schematically illustrates an example of the configuration of the work machine 100. In FIG. 4, the mechanical power transmission system, the hydraulic oil line, the pilot line, and the electric control system are indicated by double lines, bold solid lines, bold dashed lines, and dotted lines, respectively.

The driving system of the work machine 100 includes an engine 11, a regulator 13, a main pump 14, and a control valve unit 17. The hydraulic driving system of the work machine 100 includes hydraulic actuators such as the turning hydraulic motor 2A, the left traveling hydraulic motor 2ML, the right traveling hydraulic motor 2MR, the boom cylinder 7, the arm cylinder 8, and the bucket cylinder 9.

The engine 11 is an example of a power source of the work machine 100 and is mounted, for example, at the rear of the upper turning body 3. The power source of the work machine 100 may be a combination of a power source such as a battery or a fuel cell and an electric motor. Specifically, the engine 11 constantly rotates at a predetermined target rotation speed under direct or indirect control by the controller 30 to drive the main pump 14 and the pilot pump 15. The engine 11 is, for example, a diesel engine using light oil as fuel. The engine 11 may be a gasoline engine or a hydrogen engine.

The regulator 13 controls the discharge amount of the main pump 14. For example, the regulator 13 controls the discharge amount of the main pump 14 by adjusting the angle (tilt angle) of the swash plate of the main pump 14 in response to a control instruction from the controller 30.

The main pump 14, for example, like the engine 11, is mounted at the rear of the upper turning body 3 and supplies hydraulic oil to the control valve unit 17 through a hydraulic oil line. In the illustrated example, the main pump 14 is a variable displacement hydraulic pump.

The control valve unit 17 is a hydraulic control device for controlling the hydraulic system in the work machine 100. In the illustrated example, the control valve unit 17 includes control valves 171 to 176. The control valve unit 17 is configured to selectively supply hydraulic oil discharged from the main pump 14 to one or more hydraulic actuators through the control valves 171 to 176. The control valves 171 to 176 control the flow rate of hydraulic oil flowing from the main pump 14 to the hydraulic actuator and the flow rate of hydraulic oil flowing from the hydraulic actuator to the hydraulic oil tank. The hydraulic actuator includes the boom cylinder 7, the arm cylinder 8, the bucket cylinder 9, the left traveling hydraulic motor 2ML, the right traveling hydraulic motor 2MR, and the turning hydraulic motor 2A. Specifically, the control valve 171 corresponds to the left traveling hydraulic motor 2ML, the control valve 172 corresponds to the right traveling hydraulic motor 2MR, and the control valve 173 corresponds to the turning hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device, and is configured to supply hydraulic oil to the hydraulic control device via a pilot line. In the illustrated example, the pilot pump 15 is a fixed-capacity hydraulic pump. However, the pilot pressure generating device may be implemented by the main pump 14. That is, the main pump 14 may have a function of supplying hydraulic oil to the control valve unit 17 via a hydraulic oil line and a function of supplying hydraulic oil to various hydraulic control devices via a pilot line. In this case, the pilot pump 15 may be omitted.

The discharge pressure sensor 28 is configured to detect the discharge pressure of the main pump 14. In the example illustrated in the figure, the discharge pressure sensor 28 outputs the detected value to the controller 30.

An operation device 26 is a device used by an operator to operate an actuator. The operation device 26 includes, for example, an operating lever and an operating pedal. The actuator may be a hydraulic actuator or an electric actuator.

The operating sensor 29 is configured to detect the operation contents of an operator using the operation device 26. In the present embodiment, the operating sensor 29 detects the operating direction and the operating amount of the operation device 26 corresponding to each of the actuators, and outputs the detected values to the controller 30. In the illustrated example, the controller 30 can control the opening area of the proportional valve 31 according to the output of the operating sensor 29. Then, the controller 30 supplies the hydraulic oil discharged from the pilot pump 15 to the pilot port of the corresponding control valve in the control valve unit 17. The pressure (pilot pressure) of the hydraulic oil supplied to each of the pilot ports is, in principle, the pressure corresponding to the operating direction and the operating amount of the operation device 26 corresponding to each of the hydraulic actuators. Thus, the operation device 26 is configured to supply the hydraulic oil discharged from the pilot pump 15 to the pilot port of the corresponding control valve in the control valve unit 17.

The proportional valve 31, which functions as a control valve for machine control, is arranged in a pipe line connecting the pilot pump 15 and the pilot port of the control valve in the control valve unit 17, and is configured such that the flow area of the pipe line can be changed. In the illustrated example, the proportional valve 31 operates according to a control instruction output from the controller 30. Therefore, the controller 30 can adjust the pilot pressure acting on the pilot port of the control valve by the proportional valve 31 regardless of the operation of the operation device 26 by the operator.

With this configuration, the controller 30 can operate the hydraulic actuator corresponding to the specific operation device 26 even when the operation of the specific operation device 26 is not performed.

Further, as illustrated in FIG. 4, the control system of the work machine 100 includes a controller 30, a display device D1, an input device D2, a speech button KS, an external sound collecting device (an example of an external sound collecting device) M1, an internal sound collecting device (an example of an internal sound collecting device) M2, an external sound output device (an example of an external sound output device) SP1, an internal sound output device (an example of an internal sound output device) SP2, an external volume dial DL1, an internal volume dial DL2, a switch SW, a storage device 35, and a communication device T1.

The controller 30 is configured to output a control instruction to the regulator 13 as needed to change the discharge amount of the main pump 14.

The controller 30 may be configured to control, for example, the machine guidance function for guiding the manual operation of the work machine 100 by an operator through the operation device 26. The controller 30 may be configured to control, for example, the machine control function for automatically supporting the manual operation of the work machine 100 by an operator through the operation device 26.

Note that some of the functions of the controller 30 may be implemented by other controllers (control devices). That is, the functions of the controller 30 may be implemented in a manner that they are distributed among a plurality of controllers. For example, the machine guidance function and the machine control function may be implemented by an exclusive-use controller (control device).

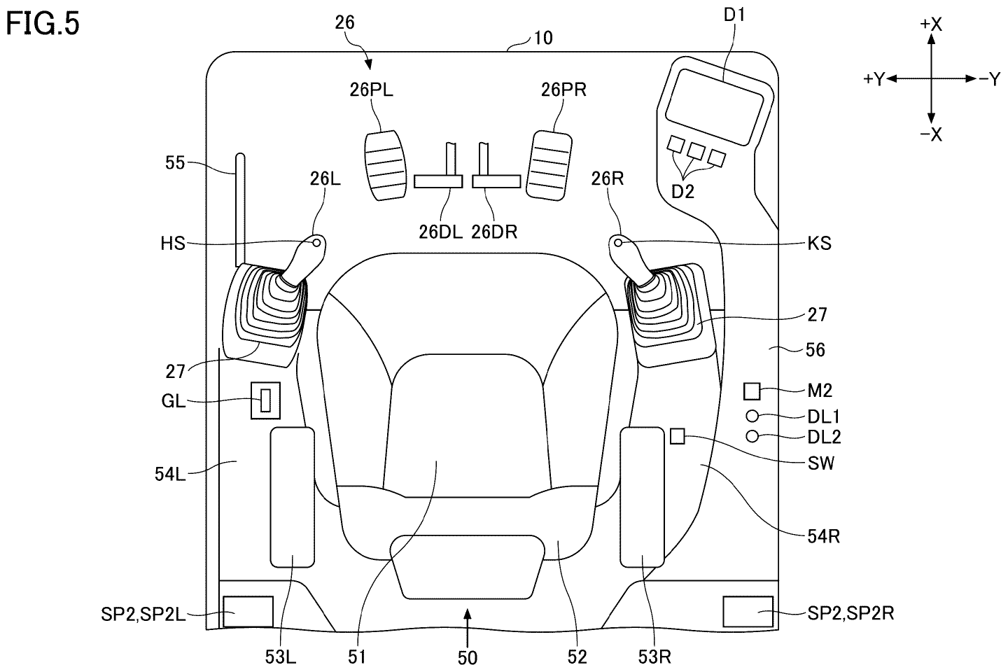

Referring now to FIG. 5, the inside of the driving room 10 will be described. FIG. 5 is a top view of the inside of the driving room 10. The work machine 100 includes a driving seat 50, the operation device 26, a display device D1, and the like, which are arranged inside the driving room 10. An access door is provided on the left side of the driving seat 50. The operator can enter the inside of the driving room 10 by opening the access door.

The driving seat 50 is arranged in the center of the driving room 10 in the top view. The driving seat 50 includes a seat 51 on which the operator sits and a backrest 52. The driving seat 50 is a reclining seat, and the inclination angle of the backrest 52 is adjustable. A left armrest 53L is arranged on the left side of the driving seat 50, and a right armrest 53R is arranged on the right side. The left armrest 53L and the right armrest 53R are rotatably supported by the backrest 52.

A left console 54L is arranged on the left side of the driving seat 50, and a right console 54R is arranged on the right side. The left console 54L and the right console 54R extend along the longitudinal direction. The driving seat 50 is slidable in the longitudinal direction. The driving seat 50 may be slidable in the longitudinal direction together with the left console 54L and the right console 54R.

The left armrest 53L is arranged on the left console 54L. The right armrest 53R is arranged on the right console 54R. The left armrest 53L is arranged so as to cover a part of the left console 54L in the top view. The right armrest 53R is arranged so as to cover a part of the right console 54R in the top view.

The operation device 26 includes a left operation lever 26L, a right operation lever 26R, a left traveling pedal 26PL, a right traveling pedal 26PR, a left traveling lever 26DL, and a right traveling lever 26DR.

The left operation lever 26L is provided at the front of the left console 54L. Similarly, the right operation lever 26R is provided at the front of the right console 54R. An operator seated on the driving seat 50 can operate the left operation lever 26L while holding the left operation lever 26L with his left hand, and can operate the right operation lever 26R while holding the right operation lever 26R with his right hand. An operator seated on the driving seat 50 can operate the left operation lever 26L with his left hand to drive the arm cylinder 8 and the turning hydraulic motor 2A. An operator seated on the driving seat 50 can operate the right operation lever 26R with his right hand to drive the boom cylinder 7 and the bucket cylinder 9. The bases of the left operation lever 26L and the right operation lever 26R are covered with lever boots 27.

The left traveling pedal 26PL and the right traveling pedal 26PR are arranged on the floor in front of the driving seat 50. An operator seated on the driving seat 50 can operate the left traveling pedal 26PL with his left foot to drive the left traveling hydraulic motor 2ML. The operator seated on the driving seat 50 can operate the right traveling pedal 26PR with his right foot to drive the right traveling hydraulic motor 2MR.

The left traveling lever 26DL and the right traveling lever 26DR are arranged between the left traveling pedal 26PL and the right traveling pedal 26PR in the top view. The left traveling lever 26DL and the right traveling lever 26DR extend upward from the floor surface in front of the driving seat 50. The operator seated on the driving seat 50 can drive the left traveling hydraulic motor 2ML in the same manner as the operation through the left traveling pedal 26PL by gripping the left traveling lever 26DL with his left hand. The operator seated on the driving seat 50 can drive the right traveling hydraulic motor 2MR in the same manner as the operation through the right traveling pedal 26PR by gripping the right traveling lever 26DR with his right hand. The left traveling lever 26DL and the right traveling lever 26DR are arranged such that the operator can simultaneously operate the left traveling lever 26DL and the right traveling lever 26DR with one hand.

The display device D1 is provided at a place easily visible to the operator seated in the driving room 10 and displays various information images under the control of the controller 30. In the illustrated example, the display device D1 is arranged in front of the right side of the driving seat 50, and is connected to the controller 30 via an exclusive-use line. The display device D1 displays various kinds of image information. The display device D1 includes a display screen for displaying information such as working conditions or operating conditions of the work machine 100. An operator seated on the driving seat 50 can perform work with the work machine 100 while confirming various kinds of information displayed on the display device D1. The display device D1 may be provided with an input device D2.

The input device D2 is provided within reach of the operator seated on the driving seat 50, receives various operation inputs by the operator, and outputs signals corresponding to the operation inputs to the controller 30. The input device D2 includes a touch panel mounted on the display of the display device D1 for displaying various information images, a knob switch provided at the tip of one or more of the plurality of operation levers included in the operation device 26, or a button switch, a lever, a toggle switch, or a rotary dial provided around the display device D1. A signal corresponding to the contents of the operation to the input device D2 is taken into the controller 30.

A gate bar 55 is attached to the front of the front end of the left console 54L. The gate bar 55 operates in conjunction with the operation state of the gate lock lever GL provided in the left console 54L. The gate bar 55 is mounted on an inner frame of the left console 54L in a liftable manner around the axis extending in the lateral direction of the upper end.

The gate lock lever GL is a mechanical input operation part for switching between a state in which operation of the work machine 100 by the operation device 26 is possible (operable state) and a state in which operation of the work machine 100 by the operation device 26 is not possible (inoperable state). In the illustrated example, the gate lock lever GL is configured such that an operator can switch between a first operation position to implement the inoperable state and a second operation position to implement the operable state. The controller 30 switches between an operable state and an inoperable state according to the operation state of the gate lock lever GL. In the illustrated example, the controller 30 switches between an operable state and an inoperable state of the work machine 100 by electrically switching between a communication state and a non-communication state of the pilot line according to the operation state of the gate lock lever GL.

Further, when the gate lock lever GL is in the second operation position, the gate bar 55 is in a state in which it is raised forward so as to prevent the operator from passing through the access door (passage prohibition state), as illustrated in FIG. 5. On the other hand, when the gate lock lever GL is in the first operation position, the gate bar 55 is in a state in which it is housed inside the left console 54L (passage permission state) so as not to prevent the operator from passing through the access door.

With this configuration, the operator cannot operate the work machine 100 unless the gate lock lever GL is set to the second operating position and the gate bar 55 is set to the passage prohibition state. Therefore, this configuration can prevent the work machine 100 from moving unintentionally even if the operator inadvertently touches the operation device 26 when getting on and off. Therefore, this configuration can improve the safety of the work machine 100.

Further, the work machine 100 may be configured to accept a predetermined operation for starting the engine 11 only when the gate lock lever GL is set to the second operating position and the gate bar 55 is set to the passage prohibition state. That is, the work machine 100 may be configured not to start the engine 11 when the gate lock lever GL is set to the first operating position and the gate bar 55 is set to the passage permission state.

A switch SW is installed in the right console 54R. A window side console 56 is installed on the right side of the right console 54R. The window side console 56 extends over the entire length in the longitudinal direction of the driving room 10 and is provided in parallel with the right console 54R. The display device D1 is installed at the front of the window side console 56. The window side console 56 is installed with an external volume dial DL1, an internal volume dial DL2, an internal sound collecting device M2, a radio tuner or the like. The radio tuner or the like may be installed in the left console 54L or the right console 54R.

The internal sound collecting device M2 is a device for collecting sounds generated in the driving room 10. In the illustrated example, the internal sound collecting device M2 is an indoor microphone and is configured to pick up voices emitted by the operator in the driving room 10.

The horn button HS is a button operated by the operator of the work machine 100 when the horn is sounded. In the illustrated example, the horn button HS is a knob switch provided at the tip of the left operation lever 26L.

The speech button KS is a button operated by the operator of the work machine 100 when the operator of the work machine 100 speaks to a worker around the work machine 100. In the illustrated example, the speech button KS is a knob switch provided at the tip of the right operation lever 26R.

The internal sound output device SP2 is a device for outputting sound to an operator in the driving room 10 and is provided in the driving room 10. The internal sound output device SP2 converts an electric signal input from the controller 30 into a physical sound (vibration of air) and outputs the sound. The internal sound output device SP2 may be provided at any position, for example, near the display device D1, near the input device D2, or near the entrance door of the driving room 10. In the illustrated example, the internal sound output device SP2 includes a left indoor speaker SP2L attached to the upper left corner of the rear wall of the driving room 10 and a right indoor speaker SP2R attached to the upper right corner of the rear wall of the driving room 10. The internal sound output device SP2 may be a headphone or earphone worn by an operator. In this case, the headphone or earphone is connected so as to be able to communicate with the controller 30 via, for example, Bluetooth (registered trademark).

The external volume dial DL1 is configured to adjust the volume of sound output by the external sound output device SP1. Further, the volume of sound output by each of the external sound output devices SP1 may be additionally configured to make adjustments by using a device other than the external volume dial DL1, such as a touch panel attached to the display device D1.

The external volume dial DL1 may be configured to rotate indefinitely in the clockwise and counterclockwise directions. This is to address a case where volume adjustment using the external volume dial DL1 and volume adjustment using a device other than the external volume dial DL1 are used together.

The internal volume dial DL2 is configured to adjust the volume of sound output by the internal sound output device SP2. Further, the volume of sound output by each of the internal sound output devices SP2 may be additionally configured to make adjustments by using a device other than the internal volume dial DL2, such as a touch panel attached to the display device D1.

The internal volume dial DL2 may be configured to rotate infinitely in both clockwise and counterclockwise directions. This is to address a case where volume adjustment using the internal volume dial DL2 and volume adjustment using a device other than the internal volume dial DL2 are used together.

The storage device 35 is provided, for example, in the driving room 10 and stores various kinds of information under the control of the controller 30. The storage device 35 is, for example, a nonvolatile storage medium such as a semiconductor memory. The storage device 35 stores information for preventing the output of sound from the internal sound output device SP2. The storage device 35 may store, for example, data related to the target work surface acquired through the communication device T1 or set through the input device D2. The target work surface may be set (stored) by the operator of the work machine 100 or set by a work manager or the like.

The switch SW is an example of an operation tool for switching the operating state of the conversation function. In the illustrated example, the switch SW is provided on the upper surface of the right console 54R. However, the switch SW may be one of the input devices D2, may be implemented by a touch panel provided on the display device D1, or may be a knob switch.

A conversation function is a function for implementing a conversation between an operator OP of the work machine 100 and a worker WK around the work machine 100 as illustrated in FIG. 6. FIG. 6 is a perspective view of the work machine 100 in which the operator OP is seated and the worker WK on the left front side of the work machine 100. FIG. 6 illustrates how the voice of the operator OP is collected by the internal sound collecting device M2 and output from the external sound output device SP1, and the voice of the worker WK is collected by the external sound collecting device M1 and output from the internal sound output device SP2. In the work machine 100 illustrated in FIG. 6, the information transmission device G1 is provided at the top of each of the four sides of the driving room 10. The front light bar G1F provided at the top of the front face of the driving room 10 emits green light, and the left light bar G1L provided at the top of the left face of the driving room 10 emits white light. In FIG. 6, a dot pattern is attached to the front light bar G1F that emits green light. When the worker WK sees the front light bar G1F that emits green light, the worker WK can recognize that his/her voice is detected by the front microphone M1F. In FIG. 6, other devices such as the imaging device S6 are not illustrated for clarity.

The operating state of the conversation function includes an on state (state illustrated in FIG. 6) in which a conversation between the operator OP and the worker WK is possible, and an off state in which a conversation between the operator OP and the worker WK is not possible. However, the operating state of the conversation function may additionally include at least one of an audible state (relating to the operator OP) in which the operator OP can hear the voice of the worker WK but the worker WK cannot hear the voice of the operator OP and a speech-enabled state (relating to the operator OP) in which the worker WK can hear the voice of the operator OP but the operator OP cannot hear the voice of the worker WK.

Specifically, when the operating state of the conversation function is switched to the ON state by operating the switch SW, the external sound collecting device M1, the external sound output device SP1, the internal sound collecting device M2, and the internal sound output device SP2 become available for use. On the other hand, when the operating state of the conversation function is switched to the OFF state by operating the switch SW, the external sound collecting device M1, the external sound output device SP1, the internal sound collecting device M2, and the internal sound output device SP2 become unavailable for use. When the operating state of the conversation function is switched to the audible state by operating the switch SW, the external sound collecting device M1 and the internal sound output device SP2 become available for use. When the operating state of the conversation function is switched to the speech-enabled state by operating the switch SW, the external sound output device SP1 and the internal sound collecting device M2 become available for use. In the illustrated example, the operator OP can speak to the worker WK using the external sound output device SP1 by speaking while pressing the speech button KS while the internal sound collecting device M2 is available for use.

Under the control of the controller 30 according to the present embodiment, the internal sound output device SP2 provided inside the driving room 10 outputs the sound collected by the external sound collecting device M1, and the external sound output device SP1 provided outside the driving room 10 outputs the sound collected by the internal sound collecting device M2. The controller 30 can switch between the output of the sound from the internal sound output device SP2 and the output of the sound from the external sound output device SP1 according to the operation of the operator, thereby implementing a two-way conversation. The controller 30 according to the present embodiment can prevent the simultaneous output of sound from the internal sound output device SP2 and the external sound output device SP1 by performing switching control of sound output according to the operation, and can prevent the occurrence of howling or the like. In the present embodiment, the method of performing the switching control is not limited, and the output from the internal sound output device SP2 provided inside the driving room 10 and the output from the external sound output device SP1 provided outside the driving room 10 may be performed simultaneously.

### [Limitation on the Output of the Sound Collected by the External Sound Output Device of the Work Machine]

Other work machines often perform work around the work machine 100. Each of the work machines emits various operating sounds including engine sounds. Therefore, in the work machine 100, while the sound collected by the external sound collecting device M1 is output from the internal sound output device SP2 provided inside the driving room 10, the operating sounds of other work machines are output to the inside of the driving room 10.

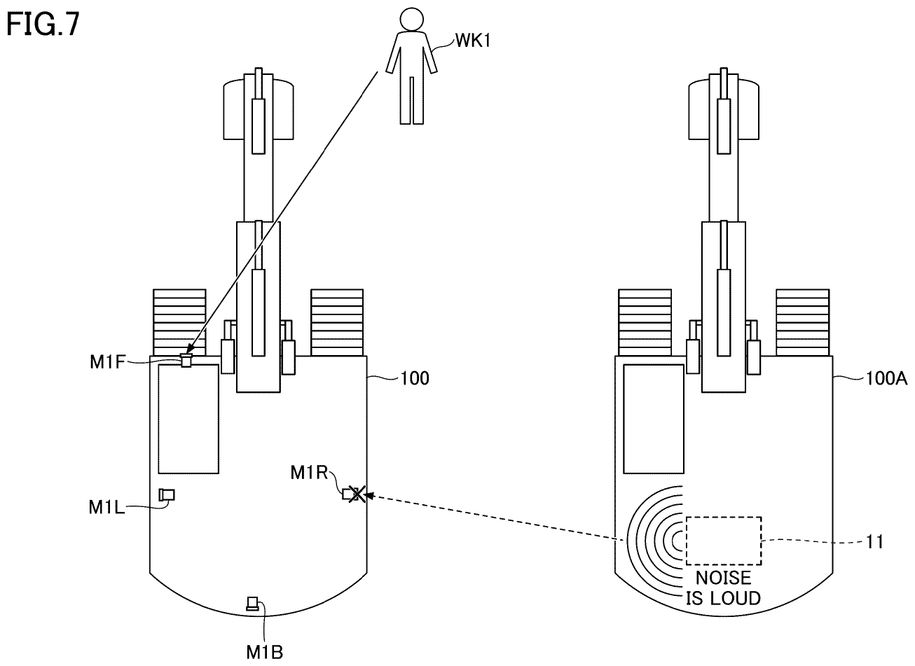

The volume of sound output by the internal sound output device SP2 of the work machine 100 will be described below. FIG. 7 is an explanatory diagram illustrating the limitation of sound in the work machine 100 according to the present embodiment. The configuration of the other work machine 100A is the same as that of the work machine 100.

In the example illustrated in FIG. 7, the work machine 100 and the other work machine 100A are present at the work site. Because the sound (an example of the operating sound) of the engine 11 of the other work machine 100A is loud, the sound of the engine 11 of the other work machine 100A reaches the right microphone M1R of the work machine 100.

Although the work machine 100 also generates the sound of the engine 11, the controller 30 of the work machine 100 can eliminate the sound of the engine 11 of the work machine 100 (which is its own device) by the noise canceling function.

When the controller 30 outputs the sound collected by the right microphone M1R from the internal sound output device SP2 provided inside the driving room 10, the sound of the engine 11 of the other work machine 100A reverberates in the driving room 10. In such a situation, for example, when the worker WK speaks to the work machine 100, the controller 30 outputs the sound collected by the front microphone M1F from the internal sound output device SP2 provided inside the driving room 10, but the voice spoken by the worker WK may be drowned out by the sound of the engine 11 of the other work machine 100A. In this case, it may be difficult for the operator to recognize the content spoken by the worker WK.

Therefore, the controller 30 according to the present embodiment limits the output of the sound collected by the external sound collecting device M1 from the internal sound output device SP2 according to the detection result of the object (for example, the other work machine 100A) existing around the work machine 100. In the example illustrated in FIG. 7, because the controller 30 detects the other work machine 100A in the right direction, the controller 30 stops outputting, from the internal sound output device SP2, the sound collected from the right microphone M1R located in the right direction from the center of the work machine 100. This control by the controller 30 limits the output of the sound of the engine 11 of the other work machine 100A to the driving room 10, making it easy for the operator to recognize the content spoken by the worker WK.

### [Functional Configuration of Controller]

Referring back to FIG. 4, a configuration in which the controller 30 limits the volume of sound output from the external sound output device SP1 will be described. The controller 30 includes an acquiring part 301, an operation receiving part 302, an output control part 303, a detecting part 304, a determining part 305, and a reporting part 306.

The acquiring part 301 acquires detection results from various sensors provided in the work machine 100. The acquiring part 301 acquires sound signals representing sounds generated around the work machine 100 from the external sound collecting device M1. Further, the acquiring part 301 acquires, from the internal sound collecting device M2, sound signals representing sounds including sounds emitted by an operator on the operation seat.

The acquiring part 301 acquires image information indicating imaging results from the imaging device S6. The acquiring part 301 acquires position information (including position and orientation) of the work machine 100 from the positioning device PS.

The acquiring part 301 acquires (receives) information from an object (for example, the external work machine 100A) around the work machine 100 or from a management apparatus managing the work site, via the communication device T1. For example, the acquiring part 301 acquires position information of an object around the work machine 100, from an object (for example, the external work machine 100A) or from a management apparatus managing the work site.

Further, the acquiring part 301 executes a noise canceling function for the sound indicated by the sound signal acquired from the external sound collecting device M1 or the internal sound collecting device M2. For the noise canceling, a well-known technique may be used. For example, it is conceivable to remove the noise component by superimposing a sound in a phase opposite to the noise component. Further, the acquiring part 301 may perform an emphasizing process on a person's voice band for the sound indicated by the sound signal acquired from the external sound collecting device M1 or the internal sound collecting device M2. Because the acquiring part 301 executes the noise canceling function, when the output control part 303 outputs the sound based on the sound signal, it is easy to understand what is being said.

The operation receiving part 302 receives an operation from the operator through one or more of the input device D2, the speech button KS, and the switch SW. For example, the operation receiving part 302 receives an operation to determine whether or not the speech button KS is pressed.

As another example, the operation receiving part 302 receives an operation to turn on the switch SW or an operation to turn off the switch SW. The controller 30 operates the voice output function when an operation to turn on the switch SW is received, and stops the voice output function when an operation to turn off the switch SW is received.

The output control part 303 performs control to output sound based on sound signals acquired from the external sound collecting device M1 or the internal sound collecting device M2, from the internal sound output device SP2 or the external sound output device SP1.

The output control part 303 performs control for outputting sound based on sound signals acquired from the external sound collecting device M1 from the internal sound output device SP2 when an operation to turn on the switch SW is received.

The output control part 303 also stops the control for outputting sound based on sound signals acquired from the external sound collecting device M1 from the internal sound output device SP2 when an operation to turn off the switch SW is received.

The output control part 303 according to the present embodiment performs control to output sound based on sound signals acquired from the internal sound collecting device M2 from the external sound output device SP1 while the operation receiving part 302 is receiving the pressing of the speech button KS.

That is, according to whether or not the speech button (an example of the first operation) KS is depressed, the output control part 303 switches between the control of outputting the sound collected by the external sound collecting device M1 from the internal sound output device SP2 and the control of outputting the sound collected by the internal sound collecting device M2 from the external sound output device SP1. With this control, the operator can talk to the person (for example, the worker WK) around the work machine at a desired timing, and the occurrence of howling or the like can be prevented.

Thus, the output control part 303 according to the present embodiment enables the output control of the sound collected by the external sound collecting device M1 from the internal sound output device SP2, and also enables the output control of the sound collected by the internal sound collecting device M2 from the external sound output device SP1. Thus, two-way conversation can be performed between the operator of the driving room 10 and the person who exists around the work machine 100. Therefore, work can be coordinated by two-way conversation, and work efficiency can be improved.

The detecting part 304 detects an object existing around the work machine 100. The detecting part 304 according to the present embodiment detects an object emitting an operating sound based on the sound signal acquired by the acquiring part 301 from the external sound collecting device M1. Any method may be used for detecting an object emitting an operating sound, regardless of the well-known method. For example, a learned model may be used as a method for detecting and processing an object emitting an operating sound.

For example, the learned model is composed mainly of a neural network. The neural network of the learned model may be what is referred to as a deep neural network having at least one intermediate layer (hidden layer) between an input layer and an output layer. In the neural network, a weighting parameter representing a connection strength with a lower layer is specified for each of a plurality of neurons constituting each intermediate layer. The neural network is configured in such a manner that the neuron in each layer outputs, to the neuron in the lower layer through a threshold function, the sum of the values obtained by multiplying the input values from the plurality of neurons in the upper layer by the weighting parameter specified for each neuron in the upper layer.

Machine learning, specifically deep learning, is performed on the learned model, and as a result, the weighting parameter of the neural network is optimized.

The training data used for machine learning of the learned model includes, for example, a sound signal and information indicating whether or not an object emitting the operating sound exists. By performing machine learning by using the training data, the learned model outputs information indicating whether or not an object emitting an operating sound exists when a sound signal is input. Further, the training data may include information identifying an object emitting an operating sound. In this case, when an object emitting an operating sound exists, the learned model outputs information identifying the object. Thus, the controller 30 can perform control corresponding to the object.

The operating sound (predetermined sound) included in the sound signal may be an operating sound emitted by the object. The operating sound emitted by the object may be a stationary noise or a non-stationary noise. When the object is a work machine, it may be, for example, an engine sound of the work machine, an impact sound of a stroke end, a hydraulic operating sound, or a sound generated when a relief valve or the like is opened.

The object may be an object emitting an operating sound, for example, a shovel, or a work machine such as a crane, asphalt finisher, forklift, dump truck, etc. Further, the object may be an object other than a work machine, for example, a compressor or the like emitting an operating sound.

The method of detecting the object emitting the operating sound is not limited to the method using the learned model. For example, based on the feature amount extracted from the sound signal, the operating sound corresponding to the feature amount may be identified, and the type of the object emitting the operating sound may be detected.

The detecting part 304 according to the present embodiment receives, from the learned model, information indicating whether or not the object emitting the operating sound exists in the sound signal, by inputting, into the learned model, the sound signal acquired from each of the four external sound collecting devices M1.

Then, based on the magnitude of the operating sound included in the sound signal acquired from each of the four external sound collecting devices M1, the detecting part 304 identifies the direction in which the object emitting the operating sound exists. For example, among the sound signals acquired by the four external sound collecting devices M1, if the sound signal of the right microphone M1R includes the largest sound, the detecting part 304 identifies that the object exists in the right direction from the work machine 100.

Further, the present embodiment does not limit the object detection method to the method using the sound signal. For example, the detecting part 304 may detect the presence or absence of an object emitting an operating sound and the direction in which the object exists by combining the sound signal and image information captured by the imaging device S6. In this case, the direction in which the object exists can be specifically specified.

By using the image information captured by the imaging device S6, it is possible to distinguish whether the sound collected by the external sound collecting device M1 is the sound emitted by the object or the sound emitted by the work machine 100 being reflected by a wall or the like. That is, when the sound is emitted by the work machine 100, the noise canceling function of the acquiring part 301 can remove the sound. When the object is not detected by the image information captured by the imaging device S6, that is, when the sound collected by the external sound collecting device M1 is recognized as the sound emitted by the work machine 100 being reflected by the wall or the like, after the acquiring part 301 executes the noise canceling function for the sound collected by the external sound collecting device M1, the output control part 303 outputs the sound after executing the noise canceling function from the internal sound output device SP2. Thus, even if the sound collected by the external sound collecting device M1 includes the operating sound, the operating sound can be removed by the noise canceling function and output from the internal sound output device SP2. Therefore, even if the stationary noise of the work machine 100 is reflected by the wall or the like, the operator can hear the sound representing the situation around the work machine 100.

Further, as a method for detecting the object, the detecting part 304 may detect the presence or absence of the object emitting the operating sound and the direction and distance where the object exists by combining the sound signal and the position information of the work machine 100 and the object. In this case, the direction and distance in which the object exists can be specifically identified. Further, as an object detection method, there is a method in which the detecting part 304 detects the presence or absence of an object emitting an operating sound and the direction and distance in which the object exists by combining the sound signal and the object detection result of the object detection device (for example, LiDAR) configured in the imaging device S6. For example, the detecting part 304 estimates an object existing in the direction and distance detected by the object detection device as an object emitting an operating sound.

Further, the detecting part 304 may detect the direction in which the object exists based on the image information captured by the imaging device S6, the position information of the work machine 100 and the object, or the object detection result of the object detection device (for example, LiDAR).

That is, as a method of detecting the direction in which the object exists, the detecting part 304 detects the object based on any one or more of the sound signals acquired from the plurality of external sound collecting devices M1, the image information captured by the imaging device S6, the position information, and the detection result of the object detection device. In the present embodiment, by identifying the direction in which the object exists, it is possible to recognize the external sound collecting device M1 for which the sound output to the driving room 10 is to be limited. Therefore, it is possible to discriminate between the external sound collecting devices M1 which may output sound from the internal sound output device SP2 and the external sound collecting device M1 whose sound output is to be limited. The controller 30 controls the output of sound based on the result of this discrimination, so that the surrounding situation can be recognized by sound while maintaining the quietness in the driving room 10.

The determining part 305 determines whether or not the sound collected by the four external sound collecting devices M1 is to be output from the internal sound output device SP2 based on the detection result by the detecting part 304. When the detecting part 304 detects an object emitting an operating sound, the determining part 305 according to the present embodiment determines whether or not the volume of sound indicated by the sound signal of the external sound collecting device M1 arranged in the direction where the object exists is greater than or equal to a predetermined threshold. The predetermined threshold is determined according to the embodiment, and a description thereof is omitted.

The determining part 305 according to the present embodiment determines whether or not the volume of sound collected from the direction where the object emitting the operating sound exists is greater than or equal to a predetermined threshold. That is, the controller 30 according to the present embodiment does not limit the sound even if the volume of sound emitted in the direction where the object does not exist is greater than or equal to a predetermined threshold. Thus, even if the sound is greater than or equal to the predetermined threshold, the operator can hear the sound other than the sound emitted by the object (for example, the operating sound), and thus can recognize abnormal sound generated in the surroundings or the sound spoken thereto by a person.

Then, the output control part 303 prevents the output from the internal sound output device SP2 of the sound collected by the external sound collecting device M1 arranged in the direction determined by the determining part 305 to be greater than or equal to the predetermined threshold.

In this way, the output control part 303 according to the present embodiment limits the output from the internal sound output device SP2 based on whether or not the sound collected by the external sound collecting device M1 includes the operating sound (an example of a predetermined sound) emitted from the object. In the present embodiment, an example of limiting the output when the volume of the sound including the operating sound is greater than or equal to a predetermined threshold is described, but the method is not limited to the method of limiting the output when the volume of sound is greater than or equal to a predetermined threshold, and the output from the internal sound output device SP2 may be limited when it is determined that the operating sound (an example of a predetermined sound) is included. Because the above-described control by the output control part 303 does not limit, for example, the sound emitted by the worker WK1, the operator can recognize the content spoken by the worker WK1.

Further, the output control part 303 according to the present embodiment limits the output from the internal sound output device SP2 of the sound collected by the external sound collecting device M1 provided in the direction where the object emitting the operating sound exists, among the plurality of external sound collecting devices M1. That is, because the sound collected by the external sound collecting device M1 provided in the direction other than the direction where the object emitting the operating sound exists is output from the internal sound output device SP2, the operator can hear the sound emitted around the work machine 100 (for example, the sound from a person in a direction other than the direction where the object exists) except for the direction where the object exists, and thus can recognize the situation around the work machine 100.

In the present embodiment, the output from the internal sound output device SP2 is stopped for the sound collected from all the external sound collecting devices M1 determined to be greater than or equal to the predetermined threshold. Therefore, the controller 30 stops the output from the internal sound output device SP2 of the sound collected from the left microphone M1L and the right microphone M1R, for example, when the operating sound from other work machines located on the left and right sides of the work machine 100 is determined to be greater than or equal to the predetermined threshold.

The reporting part 306 makes a report based on the sound limitation. The reporting method may be any method, for example, a reporting sound may be output from the internal sound output device SP2 in the driving room 10, or pop-up display may be performed on the display device D1. Specifically, the reporting part 306 reports about the sound limitation based on the determination result by the determining part 305. For example, when the determining part 305 determines that the volume of sound collected by the right microphone M1R is greater than or equal to a predetermined threshold, the reporting part 306 displays on the display device D1 that the output of the sound collected from the right microphone M1R is stopped. In the present embodiment, the operator can recognize the situation of the sound output from the internal sound output device SP2 according to the reporting by the reporting part 306. Therefore, in the present embodiment, because the operator can operate the work machine 100 in consideration of the situation, safety can be improved.

Further, the present embodiment is not limited to the mode in which the reporting part 306 displays on the display device D1 that the output of the sound collected from the right microphone M1R is stopped when the determining part 305 determines that the volume of sound collected from the right microphone M1R is greater than or equal to a predetermined threshold. For example, when the determining part 305 determines that the volume of sound collected from any external sound collecting device M1 is greater than or equal to a predetermined threshold, the reporting part 306 displays, on the display device D1, a confirmation screen asking whether the output of the sound collected by the external sound collecting device M1 can be stopped. When the operation receiving part 302 receives an operation to the effect that the output may be stopped, the output control part 303 stops the output of the sound collected by the external sound collecting device M1.

As a modified example, when the detecting part 304 estimates the position of the object emitting the operating sound, the reporting part 306 pops up a message indicating that the output of the operating sound of the object is stopped. For example, when the display device D1 displays image information captured by the imaging device S6, the detecting part 304 estimates the position of the object emitting the operating sound based on the position information, image information, or the detection result of the object detecting device. Then, the reporting part 306 identifies the position of the object appearing in the image information based on the position of the object detected by the detecting part 304, and indicates the object appearing in the image information with a speech bubble or the like. In the speech bubble, for example, a message indicating that the output of the sound is stopped because of the operating sound of the object, is displayed.

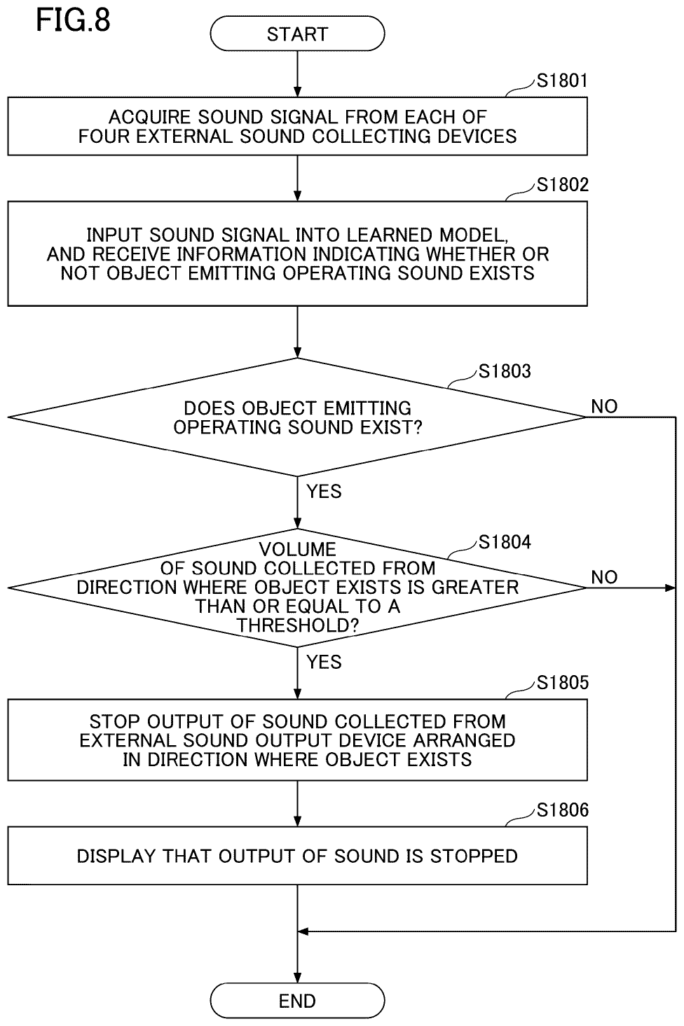

Next, the processing procedure executed by the controller 30 according to the present embodiment will be described. FIG. 8 is a flowchart illustrating the processing procedure for limiting the output of the sound according to the operating sound emitted by the object in the controller 30 according to the present embodiment.

The acquiring part 301 acquires sound signals representing sounds generated around the work machine 100 from each of the four external sound collecting devices M1 (S1801).

The detecting part 304 inputs sound signals acquired from each of the four external sound collecting devices M1 to the learned model, to receive information indicating whether or not an object emitting an operating sound exists (S1802).

The detecting part 304 detects whether or not an object emitting an operating sound exists based on the received information (S1803). If the presence of the object is not detected (S1803: NO), the process ends.

On the other hand, if the detecting part 304 detects the presence of an object (S1803: YES), the determining part 305 determines whether or not the volume of sound collected from the direction where the object exists is greater than or equal to a predetermined threshold based on the acquired sound signal (S1804). If it is determined that the volume of sound is not greater than or equal to the predetermined threshold (S1804: NO), the process ends.

On the other hand, if the determining part 305 determines that the volume of sound is greater than or equal to the predetermined threshold value (S1804: YES), the output control part 303 stops the output of the sound collected from the external sound collecting device M1 arranged in the direction where the object exists, from the internal sound output device SP2 (S1805).

Then, the reporting part 306 displays on the display device D1 that the output of the sound collected from the external sound collecting device M1 arranged in the direction where the object exists has been stopped (S1806).

In the present embodiment, by the processing procedure described above, the output from the internal sound output device SP2 of the sound collected by the external sound collecting device M1 arranged in the direction where the object emitting the operating sound exists is stopped, so that the quietness in the driving room 10 can be improved.

### Modified Example 1 of First Embodiment

The work machine 100 according to the above-described embodiment is provided with four external sound collecting devices M1. However, the above-described embodiment does not limit the number of external sound collecting devices M1 provided in the work machine 100. In this modified example, the work machine 100 is provided with one external sound collecting device M1.

The detecting part 304 and the determining part 305 of this modified example perform the same processing as in the above-described embodiment. Then, the output control part 303 stops the output from the internal sound output device SP2 of the sound collected by the external sound collecting device M1 when the determining part 305 determines that the volume of sound collected from the direction in which the object exists is greater than or equal to a predetermined threshold. In this modified example, when an object emitting an operating sound exists around the work machine 100, the sound collected by the external sound collecting device M1, that is, the sound collected from around the work machine 100, can be stopped from being output from the internal sound output device SP2 to improve the quietness in the driving room 10. That is, when there is only one external sound collecting device M1 and the output from the internal sound output device SP2 is stopped, the operator cannot hear the sound generated around the work machine 100. However, when the operating sound of the object around the work machine 100 is loud, even if the sound collected from around the work machine 100 is output from the internal sound output device SP2, the operator cannot hear other sounds because they are drowned out by the operating sound. Therefore, in this modified example, the quietness in the driving room 10 is improved by stopping the output from the internal sound output device SP2.

### Modified Example 2 of First Embodiment

As an example of limiting the output of sound, the controller 30 according to the embodiment described above stops the output of sound. However, the embodiment described above does not limit the output of sound to stopping the output of sound. In this modified example, an example of adjusting the noise canceling function instead of stopping the output of sound will be described.

The detecting part 304 and the determining part 305 of this modified example perform the same processing as in the embodiment described above. When the determining part 305 determines that the volume of sound collected from the direction in which the object exists is greater than or equal to a predetermined threshold, the determining part 305 controls the acquiring part 301 to increase the gain of the noise canceling function for the sound collected by the external sound collecting device M1 arranged in the direction in which the object exists, compared with the gain before the determination of the volume of sound to be greater than or equal to the predetermined threshold, that is, before the detection of the object. That is, the acquiring part 301 eliminates the stationary noise included in the sound collected by the external sound collecting device M1 arranged in the direction in which the object exists. Therefore, the controller 30 of this modified example can realize improvement of the quietness in the driving room 10.

### Second Embodiment

In the above-described embodiment, an example of limiting the output of the sound collected by the external sound collecting device M1 arranged in the direction where the object emitting the operating sound exists has been described. After this control, if a worker exists in the direction where the object exists, it becomes difficult to hear the voice of the worker. Therefore, in the present embodiment, a configuration in which the voice of the worker can be heard will be described.

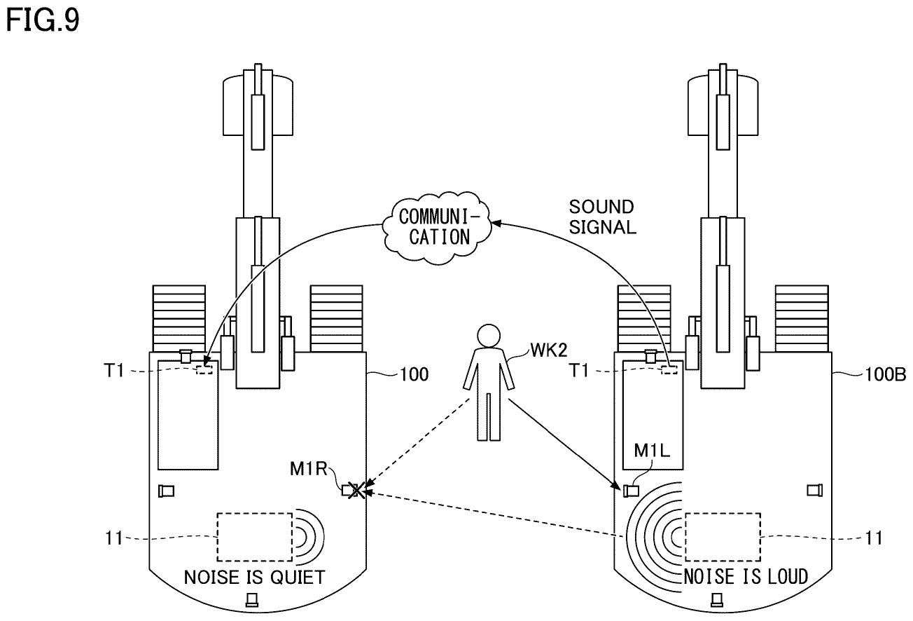

FIG. 9 is an explanatory diagram illustrating the control between the work machine 100 and another work machine 100B according to the present embodiment. In the example illustrated in FIG. 9, the work machine 100 and the other work machine 100B exist at the work site. The configuration of the other work machine 100B is the same as that of the work machine 100.

Because the sound of the engine 11 of the other work machine 100B is loud, the sound of the engine 11 of the other work machine 100B reaches the right microphone M1R of the work machine 100.

The controller 30 according to the present embodiment stops outputting, from the internal sound output device SP2, the sound collected by the right microphone M1R arranged in the direction where the other work machine 100B exists, according to the detection result of the other work machine 100B.

On the other hand, because the sound of the engine 11 of the work machine 100 is small, it does not reach the left microphone M1L of the other work machine 100B, or the sound that does reach is smaller than the predetermined threshold. Therefore, the controller 30 of the other work machine 100B continues outputting, from the internal sound output device SP2, the sound collected from the left microphone M1L.

In this situation, it is assumed that the worker WK2 existing between the work machine 100 and the other work machine 100B emits sound.

In this case, because the controller 30 of the work machine 100 stops outputting, from the internal sound output device SP2, the sound collected from the right microphone M1R, the output of the sound of the worker into the driving room 10 is prevented.

On the other hand, because the controller 30 of the other work machine 100B outputs, from the internal sound output device SP2, the sound collected by the left microphone M1L, the operator of the other work machine 100B can hear the sound of the worker WK2.

Further, in the present embodiment, the controller 30 of the other work machine 100B transmits a sound signal indicating the sound collected from the left microphone M1L to the work machine 100 via the communication device T1. Any communication method may be used between the other work machine 100B and the work machine 100, for example, Wi-Fi (registered trademark) or Bluetooth (registered trademark) may be used.

The acquiring part 301 of the controller 30 of the work machine 100 receives the sound signal acquired by the object via the communication device T1. The output control part 303 performs control to output the sound indicated by the received sound signal, from the internal sound output device SP2. Thus, the operator of the work machine 100 can hear the sound of the worker WK2.

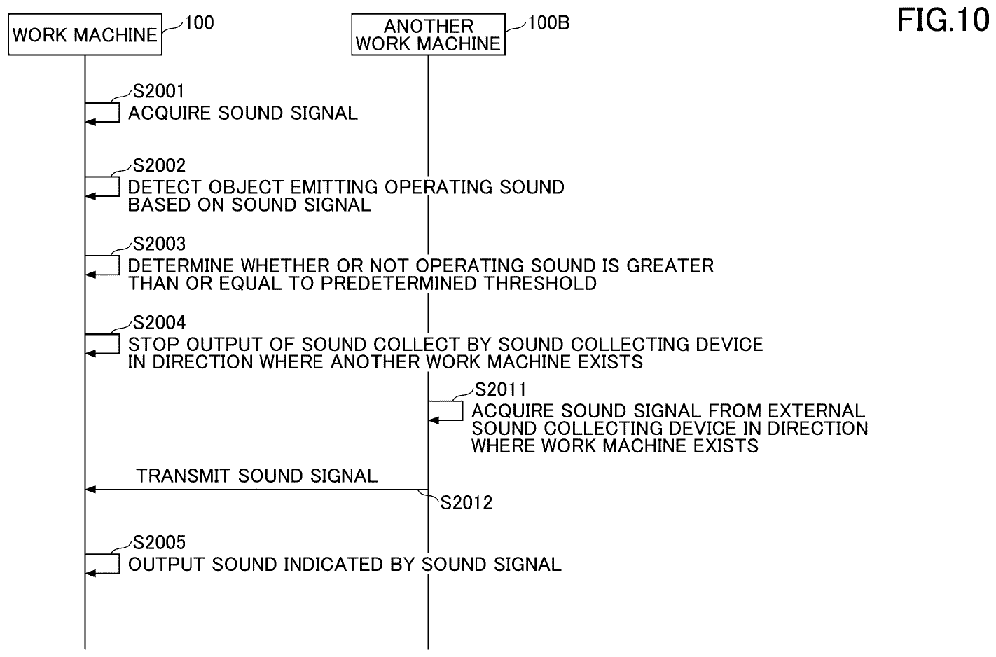

Next, the control performed between the work machine 100 and the other work machine 100B according to the present embodiment will be described. FIG. 10 is a sequence diagram illustrating the control performed between the work machine 100 and the other work machine 100B according to the present embodiment.

The acquiring part 301 of the work machine 100 acquires sound signals representing sounds generated around the work machine 100 from each of the four external sound collecting devices M1 (S2001).

Based on the sound signals, the detecting part 304 detects the other work machine (an example of an object) 100B emitting operating sounds (S2002). In the present embodiment, as in the above-described embodiment, a method using a learned model is used, and a description thereof is omitted.

Based on the acquired sound signals, the determining part 305 determines whether the volume of sound collected from the direction in which the other work machine 100B exists is greater than or equal to a predetermined threshold (S2003). In this sequence diagram, it is determined whether the volume of the collected sound is greater than or equal to a predetermined threshold.

Then, the output control part 303 stops the output, from the internal sound output device SP2, of the sound collected by the external sound collecting device M1 arranged in the direction in which the other work machine 100B exists (S2004). In the same manner as the above-described embodiment, the reporting part 306 displays on the display device D1 that the output of the sound collected by the external sound collecting device M1 arranged in the direction in which the object exists, is stopped.

The controller 30 of the other work machine 100B acquires a sound signal from the external sound collecting device M1 arranged in the direction in which the work machine 100 exists (S2011).

In this sequence diagram, the operating sound of the work machine 100 is assumed to be small. Therefore, the controller 30 of the other work machine 100B continues to output, from the internal sound output device SP2, the sound collected by the external sound collecting device M1 arranged in the direction in which the work machine 100 exists. The controller 30 of the other work machine 100 may recognize that the controller 30 is to stop outputting, from the internal sound output device SP2, the sound collected by the external sound collecting device M1 arranged in the direction in which the other work machine 100B exists based on the information transmitted from the work machine 100.

The controller 30 of the other work machine 100B transmits the sound signal acquired from the external sound collecting device M1 arranged in the direction in which the work machine 100 exists, to the work machine 100 via the communication device T1 (S2012).

The output control part 303 outputs, from the internal sound output device SP2, a sound indicating a sound signal received from the other work machine 100B (S2005).

By performing the control described above, the work machine 100 according to the present embodiment limits the output of the sound output from the external sound collecting device M1 in the direction where the other work machine 100B exists, and also enables the output of the sound of the worker WK1 existing in the direction of the other work machine 100B. Therefore, it is possible to implement both the improvement of the quietness of the driving room 10 and the recognition of spoken content.

### Third Embodiment

In the above-described embodiment, an example of limiting the output of the sound collected from the external sound collecting device M1 arranged in the direction where the other work machine exists, when the object such as the other work machine generates a stationary noise such as an operating sound, has been described. However, the above-described embodiment does not limit the method to stopping the output of the stationary noise from the internal sound output device SP2 when the object generates a stationary noise. Therefore, in the third embodiment, a case of limiting the output of non-stationary noise such as an impact sound generated by the configuration of the object will be described.

Non-stationary noise will be described. For example, in the work machine 100 or other work machine 100B, when the bucket 6 is moved in the opening direction 1701, the bucket cylinder 9 reaches the stroke end and an impact sound is generated. Whether or not such an impact sound is generated can be recognized according to the open state of the bucket 6, that is, the operation signal for opening the bucket 6 or the current position and speed of the bucket 6 (bucket angle, bucket angular velocity).

As another example, in the work machine 100 or other work machine 100B, the attachment AT is lifted up. In such a state, when the boom 4 is suddenly stopped after the boom 4 is lowered, the rear part of the work machine or the other work machine rises and falls. When the boom 4 falls, the crawler 1C of the work machine 100 or other work machine 100B contacts the ground, and an impact sound is generated. Whether such an impact sound is generated can be recognized depending on the current position of the boom 4 and the operation of the boom 4, that is, the operation signal for operating the boom 4, or the state of the boom 4 (boom angle, boom angular velocity).

In this way, the determining part 305 of the controller 30 of the work machine 100 recognizes the current operation situation of the object, and determines whether a non-stationary noise is generated based on the operation situation. Then, when it is determined by the determining part 305 that non-stationary noise is generated, the output control part 303 limits the output, from the internal sound output device SP2, of the sound collected by the external sound collecting device M1 arranged in the direction where the object exists.

The controller 30 of the present embodiment may perform control combined with the control of the above-described embodiment. For example, the controller 30 determines that the sound collected by the external sound collecting device M1 arranged in the direction where the object exists is smaller than a predetermined threshold value by the control of the above-described embodiment, and therefore outputs, from the internal sound output device SP2, the sound collected by the external sound collecting device M1. In such a situation, when the determining part 305 determines that non-stationary noise is generated at the object, the output control part 303 limits the output, from the internal sound output device SP2, of the sound collected by the external sound collecting device M1 arranged in the direction where the object exists.

In the present embodiment, the object (for example, the other work machine 100B) transmits operation information indicating the situation of the object to the work machine 100. In the present embodiment, the operation signal of the object (for example, the other work machine 100B) is used as the operation information. In the present embodiment, the operation information is not limited to the operation signal, but may be, for example, a boom angle, a boom angular velocity, a bucket angle, a bucket angular velocity, etc., as long as the current situation of the object can be recognized with the information.

Then, the controller 30 of the work machine 100 determines whether or not non-stationary noise is generated at the object based on the received operation information. A learned model may be used to determine whether or not non-stationary noise is generated.

The training data used for machine learning of the learned model includes, for example, operation information and information indicating the current operation situation of the object indicated by the operation information. By performing machine learning by using the training data, the learned model outputs information indicating the current operation situation of the object when the operation information is input. Therefore, the determining part 305 can identify the current operation situation of the object.

Based on the information indicating the current operation situation of the object, received from the learned model, the determining part 305 determines whether or not non-stationary noise is generated at the object. For example, the determining part 305 determines whether or not an impact sound is generated when the bucket cylinder 9 of the object reaches the stroke end in the current operation situation.

When the determining part 305 determines that a non-stationary noise is generated at the object, the output control part 303 limits the output, from the internal sound output device SP2, of the sound collected by the external sound collecting device M1 arranged in the direction in which the object exists.

Thus, the controller 30 according to the present embodiment receives information indicating the operating state of the object from the object, and limits the output, from the internal sound output device SP2, of the sound collected by the external sound collecting device M1, based on the operation information.

As a modified example, when the detecting part 304 estimates the position of the object around the work machine 100, and the determining part 305 determines that a non-stationary noise is generated at the object, the reporting part 306 pops up a message indicating that the output of sound is stopped because a non-stationary noise is generated at the object. For example, when the display device D1 displays image information captured by the imaging device S6, the detecting part 304 estimates the position of the object causing the non-stationary noise based on the position information, image information, or the detection result of the object detection device. Then, the reporting part 306 identifies the position of the object indicated in the image information based on the position of the object detected by the detecting part 304, and displays the object indicated in the image information with a speech bubble or the like. In the speech bubble, for example, a message indicating that the output of sound is stopped because a non-stationary noise is presumed be generated at the object is displayed.

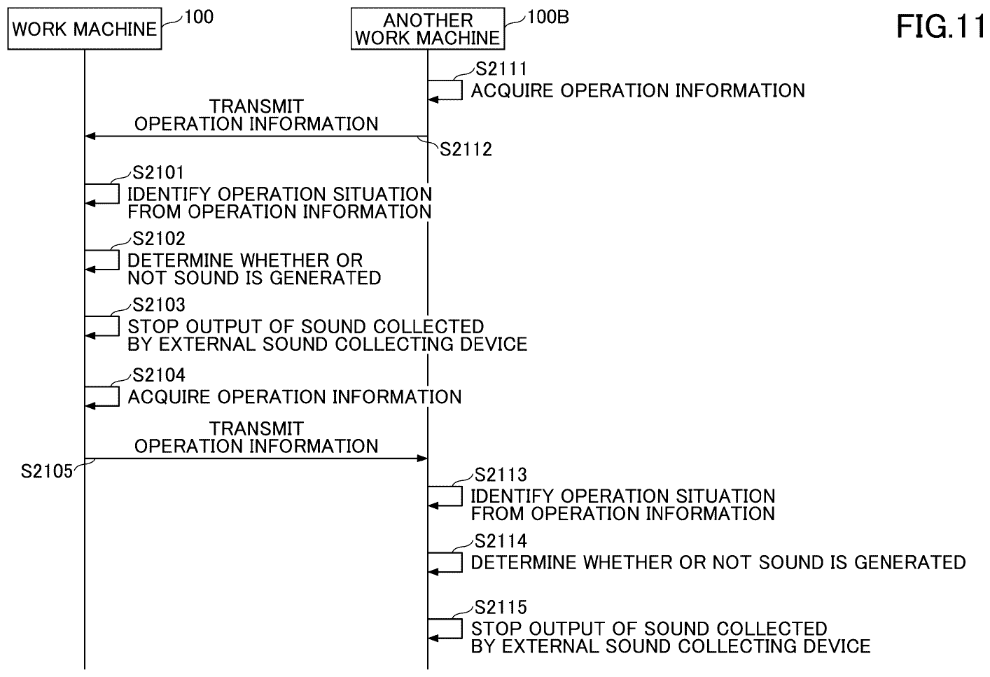

Next, the control performed between the work machine 100 and the other work machine 100B according to the present embodiment will be described. FIG. 11 is a sequence diagram illustrating the control performed between the work machine 100 and the other work machine 100B according to the present embodiment. It is assumed that the work machine 100 has the same configuration as the other work machine 100B.

The acquiring part 301 of the other work machine 100B acquires operation information (e.g., an operation signal) by which the current operation situation of the other work machine 100B can be identified (S2111).

The output control part 303 of the other work machine 100B transmits the acquired operation information to the work machine 100 via the communication device T1 (S2112).

The determining part 305 of the work machine 100 identifies the current operation situation of the other work machine 100B based on the received operation information (S2101). Next, the determining part 305 determines, according to the operation situation, whether or not sound (non-stationary noise) is generated at the other work machine 100B (S2102). In this sequence diagram, it is determined that sound (non-stationary noise) is generated.

Then, the output control part 303 stops the output, from the internal sound output device SP2, of the sound collected by the external sound collecting device M1 arranged in the direction in which the other work machine 100B exists (S2103). Similarly to the above-described embodiment, the reporting part 306 displays on the display device D1 that the output of the sound collected by the external sound collecting device M1, arranged in the direction in which the object exists, has been stopped.

The acquiring part 301 of the work machine 100 acquires operation information (for example, an operation signal) by which the current operation situation of the work machine 100 can be identified (S2104).

The output control part 303 of the work machine 100 transmits the acquired operation information to the other work machine 100B via the communication device T1 (S2105).

The determining part 305 of the other work machine 100B identifies the current operation situation of the work machine 100 based on the received operation information (S2113). Next, the determining part 305 determines whether or not non-stationary noise is generated at the work machine 100 according to the operation situation (S2114). In this sequence diagram, it is determined that a non-stationary noise is generated.

Then, the output control part 303 of the other work machine 100B stops the output, from the internal sound output device SP2, of the sound collected from the external sound collecting device M1 arranged in the direction in which the work machine 100 exists (S2115). Similarly to the above-described embodiment, the reporting part 306 displays on the display device D1 that the output of the sound collected from the external sound collecting device M1, arranged in the direction in which the object exists, has been stopped.

In the present embodiment, when a non-stationary noise is generated at the object, the output, from the internal sound output device SP2, of the sound collected from the external sound collecting device M1, arranged in the direction in which the object exists, can be stopped. Therefore, even when a non-stationary noise is generated, the quietness of the driving room 10 can be improved.

### Modified Example of Third Embodiment

In the above-described embodiment, the case in which the output of the non-stationary noise such as the impact sound generated in the configuration of the object is limited based on the received operation information has been described. However, the above-described embodiment is not limited to the method of limiting the output of the non-stationary noise based on the operation information. In the modified example, a case in which information other than the operation information is used to limit the output of the non-stationary noise will be described. In this modified example, the image information captured by the imaging device S6 or the detection result obtained by the object detection device is used.

Based on the image information captured by the imaging device S6 or the detection result obtained by the object detection device, the determining part 305 of the work machine 100 according to the modified example determines the current operation situation of the object existing at the work machine 100, and determines whether or not non-stationary noise is generated by the object according to the operation situation. The determination method for the operation situation of each object and the determination method for whether or not non-stationary noise is generated may be a known method, or the determination method may be performed by using a learned model, for example.

The output control part 303 stops the output, from the internal sound output device SP2, of the sound collected by the external sound collecting device M1 arranged in the direction in which the object exists, when it is determined that the object generates non-stationary noise.

### Fourth Embodiment

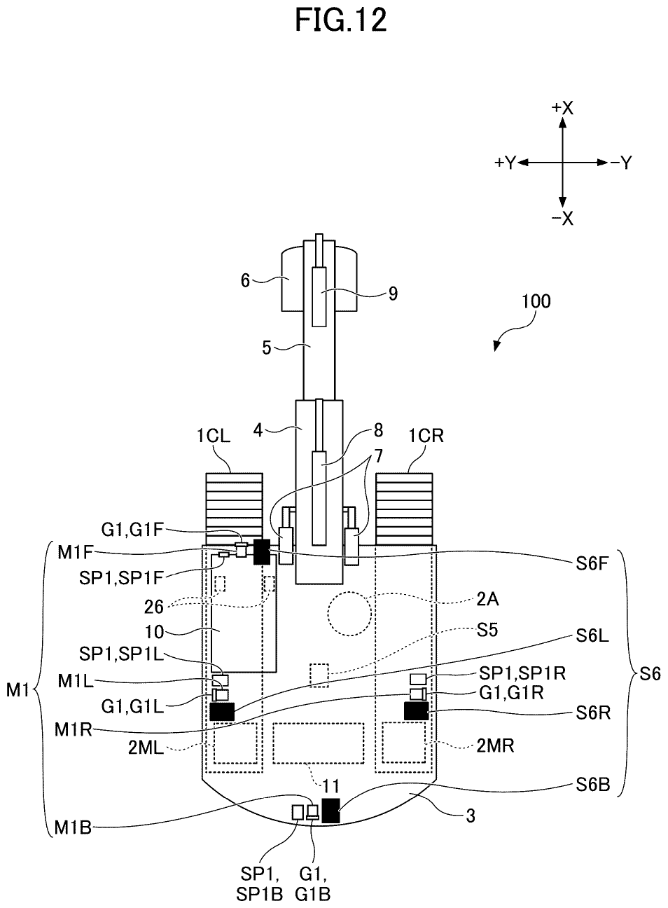

Next, another configuration example of the work machine 100 according to the fourth embodiment will be described with reference to FIG. 12. FIG. 12 is a top view of another configuration example of the work machine 100 according to the fourth embodiment. The work machine 100 illustrated in FIG. 12 differs from the work machine 100 illustrated in FIG. 1 in that the external sound output device SP1 includes four speakers (a front speaker SP1F, a left speaker SP1L, a right speaker SP1R, and a rear speaker SP1B). In the work machine 100 illustrated in FIG. 1, the external sound output device SP1 includes one non-directional speaker provided above the driving room 10.

With this configuration, the work machine 100 illustrated in FIG. 12 can output sound toward the workers WK in front of the work machine 100 without outputting sound toward the worker WK at the left, right, and rear of the work machine 100, by turning on the front speaker SP1F (the state in which sound can be output) and turning off the left speaker SP1L, the right speaker SP1R, and the rear speaker SP1B (the state in which sound cannot be output), for example.

In the example illustrated in FIG. 12, the front camera S6F and the front microphone M1F are provided adjacent to the front speaker SP1F, and the front light bar G1F is provided in the case of the front microphone M1F. The left camera S6L and the left microphone M1L are provided adjacent to the left speaker SP1L, and the left light bar G1L is provided in the case of the left microphone M1L. The right camera S6R and the right microphone M1R are provided adjacent to the right speaker SP1R, and the right light bar G1R is provided in the case of the right microphone M1R. The rear camera S6B and the rear microphone M1B are provided adjacent to the rear speaker SP1B, and the rear light bar G1B is provided in the chassis of the rear microphone M1B.

By this configuration, the work machine 100 can turn on the light bar corresponding to the turned-on speaker (light emission enabled state) and turn off the light bar corresponding to the turned-off speaker (light emission disabled state).

The external sound output device SP1 may include one or a plurality of parametric speakers. The parametric speaker is a speaker using ultrasonic waves that can selectively transmit sound to a person within a specific narrow range. The parametric speaker can transmit sound to any position.

In the work machine 100 illustrated in FIG. 12, the controller 30 may detect the worker WK around the work machine 100 based on the image captured by the imaging device S6, and identify the position of the worker WK. If there are a plurality of workers WK around the work machine 100, the controller 30 may discriminate between the conversation target (the worker WK who is speaking) and the non-target (the worker WK who is not speaking) based on the outputs of the four external sound collecting devices M1. The controller 30 may discriminate between the conversation target (the worker WK who is facing the work machine 100) and the non-target (the worker WK who is not facing the work machine 100) based on the image captured by the imaging device S6. Then, the controller 30 may turn on the speaker and the light bar facing the worker WK. For example, if there is a worker WK (speaking) behind the work machine 100, the controller 30 may turn on the rear speaker SP1B while keeping the front speaker SP1F, the left speaker SP1L, and the right speaker SP1R off. In this case, the controller 30 may turn on the rear light bar G1B while keeping the front light bar G1F, the left light bar G1L, and the right light bar G1R off. Such a function may be implemented in the work machine 100 illustrated in FIGS. 1 to 5.

With this configuration, the controller 30 can output sound in the direction where the worker WK is located without outputting sound in the direction where the worker WK is not located. Therefore, the worker WK can easily recognize whether he/she is a conversation target or a non-target.

### Fifth Embodiment

In the fifth embodiment, a case where the operator performs remote operation of the work machine 100 will be described.

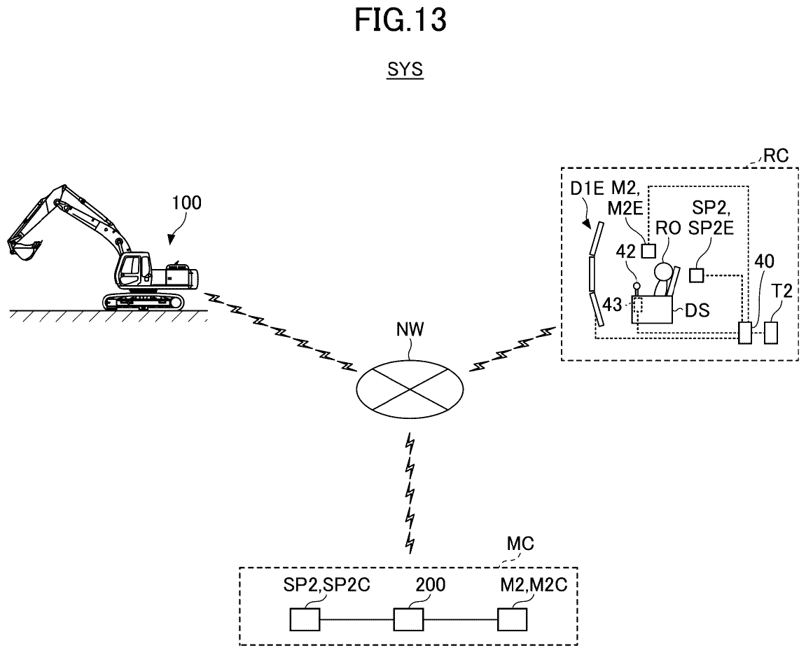

Next, with reference to FIG. 13, a configuration example of the operation system (one example of a control system) SYS according to the fifth embodiment will be described. FIG. 13 is a schematic diagram illustrating a configuration example of the operation system SYS. As illustrated in FIG. 13, the operation system SYS includes the work machine 100, the remote control room RC, and the management center MC. In FIG. 13, the detailed configuration of the work machine 100 is not illustrated. This is because the work machine 100 illustrated in FIG. 13 has the same configuration as the work machine 100 illustrated in FIG. 1 or 12.

The work machine 100, the remote control room RC, and the management center MC are connected to each other so that data can be transmitted and received via the communication network NW. The work machine 100, the remote control room RC, and the management center MC may be connected to each other so that data can be transmitted and received directly without the communication network NW. In the illustrated example, the work machine 100 transmits information about the work site to the remote control room RC. Thus, the remote operator RO in the remote control room RC can identify the situation of the work site based on the information from the work machine 100.

For example, the work machine 100 transmits image information captured by the imaging device S6 and a sound signal representing sound collected by the external sound collecting device M1 to the remote control room RC.

The work machine 100 is provided with a sensor capable of recognizing the position and shape of objects in the work site in three dimensions. For example, the work machine 100 is provided with a space recognition device. Therefore, the work machine 100 can transmit the result of measuring the work site in three dimensions to the remote control room RC.

The space recognition device is a device for recognizing the space around the work machine 100. In the illustrated example, the space recognition device is a LiDAR. The LiDAR measures the distance between each of 1 million or more points within the monitoring range and the LiDAR. The space recognition device may be any device capable of measuring the distance to an object. For example, the space recognition device may be a stereo camera or a combination of the imaging device S6 and a distance measuring device such as a millimeter wave radar.

The work machine 100 included in the operation system SYS may be one or more machines. When a plurality of work machines 100 are included, the remote operator RO of a specific work machine 100 can obtain information on the working site obtained by one or more other work machines 100 in addition to the information on the working site obtained by the specific work machine 100.

A communication device T2, a remote controller 40, an operation device 42, an operation sensor 43, a display device D1E, an internal sound collecting device M2E, and an internal sound output device SP2E are installed in the remote control room RC. An operation seat DS on which the remote operator RO who remotely operates the work machine 100 sits is installed in the remote control room RC.

The communication device T2 is configured to communicate with the communication device T1 attached to the work machine 100.

The remote controller 40 is an operation device that executes various operations. In the present embodiment, the remote controller 40 is composed of a microcomputer including a CPU and a memory. Various functions of the remote controller 40 are implemented by the CPU executing programs stored in the memory.

The display device D1E can display various kinds of information. The display device D1E displays an image based on information transmitted from the work machine 100 in order for the remote operator RO in the remote control room RC to visually recognize the surroundings of the work machine 100. In the illustrated example, the display device D1E is a liquid crystal display that displays an image captured by the imaging device S6 mounted in the work machine 100. Note that the display device D1E may be a display or a projector for implementing the naked-eye stereoscopic vision, or VR goggles or the like.

The internal sound collecting device M2E is a device for collecting sounds generated in the remote control room RC. In the illustrated example, the internal sound collecting device M2E is an indoor microphone, and is configured to pick up voices emitted by the remote operator RO in the remote control room RC.

The internal sound output device SP2E can output various kinds of sound information. The internal sound output device SP2E outputs sound based on information transmitted from the work machine 100 so that the remote operator RO in the remote control room RC can hear the sound emitted at the work site. For example, the internal sound output device SP2E may be configured to output the sound captured by the external sound collecting device M1 mounted outside the driving room 10 or the internal sound collecting device M2 mounted inside the driving room 10. In this case, the internal sound collecting device M2 may be provided in the driving room 10 at a position corresponding to the ear position of the operator sitting on the driving seat 50. The internal sound output device SP2E may be an installed device such as a speaker or a wearable device such as an earphone or a headphone. The speaker may be a monaural speaker, a stereo speaker, or a surround speaker. The speaker may be a non-directional speaker or a directional speaker. The wearable device may have a noise canceling function, a spatial audio function (stereo sound function), or a bone conduction function.

An operation sensor 43 for detecting the operation contents of the operation device 42 is installed in the operation device 42. The operation sensor 43 is, for example, an inclination sensor for detecting the inclination angle of the operation lever or an angle sensor for detecting the oscillation angle of the operation lever around the oscillation shaft. The operation sensor 43 may be composed of other sensors such as a pressure sensor, a current sensor, a voltage sensor, or a distance sensor. The operation sensor 43 outputs information about the detected operation contents of the operation device 42 to the remote controller 40. The remote controller 40 generates an operation signal based on the received information and transmits the generated operation signal to the work machine 100. The operation sensor 43 may be configured to generate an operation signal. In this case, the operation sensor 43 may output the operation signal to the communication device T2 without passing through the remote controller 40. With this configuration, the remote operator RO can remotely operate the work machine 100 from the remote control room RC.

Like the controller 30 of the first to third embodiments, the remote controller 40 includes the acquiring part 301, the operation receiving part 302, the output control part 303, the detecting part 304, the determining part 305, and the reporting part 306.

The acquiring part 301 of the remote controller 40 acquires a sound signal representing the sound collected by the external sound collecting device M1 from the work machine 100 via the communication device T2. Further, the acquiring part 301 acquires a sound signal representing the sound collected by the internal sound collecting device M2E of the remote control room RC.

The output control part 303 of the remote controller 40 can implement control, via the communication device T2, to output the sound based on the sound signal acquired from the external sound collecting device M1 by the acquiring part 301, from the internal sound output device SP2E of the remote control room RC. Thus, the remote operator RO can hear the sound of a person existing around the work machine 100.

The output control part 303 of the remote controller 40 can implement control, via the communication device T2, to output the sound based on the sound signal acquired from the internal sound collecting device M2E of the remote control room RC by the acquiring part 301, from the external sound output device SP1 of the work machine 100. Thus, a person existing around the work machine 100 can hear the voice of the remote operator RO.

The operation receiving part 302, the output control part 303, the detecting part 304, the determining part 305, and the reporting part 306 of the remote controller 40 perform the same control as the controller 30 of the above-described embodiment.

The remote controller 40 can implement the same control as the controller 30 of the above-described embodiment by having the above-described configuration.

That is, the remote controller 40 limits the output, from the internal sound output device SP2, of the sound collected by the external sound collecting device M1, according to the detection result of the object existing near the work machine 100.

The management center MC is a facility provided with various devices for managing the remote operation or the like of the work machine 100 by the remote operator RO in the work machine 100 at the work site or in the remote control room RC. In the illustrated example, the management center MC is installed at a position apart from the work site of the work machine 100 and the remote control room RC. In the management center MC, the management device 200, the internal sound collecting device M2C, and the internal sound output device SP2C are installed.

The management device 200 is an example of a control device, such as a server computer (what is referred to as a cloud server) or an edge server. The management device 200 is typically a fixed terminal device, but may be a portable terminal device (for example, a laptop computer, a tablet, or a smartphone).

The management device 200 performs the same control as that of the remote controller 40 described above. Thus, when the internal sound output device SP2C outputs the sound collected around the work machine 100, the internal sound output device SP2C is prevented from outputting the sound collected by the external sound collecting device M1 according to the operation of the work machine 100.

With this configuration, the manager in the management center MC can listen to the sound generated at the work site by using, for example, the sound collecting device (the external sound collecting device M1 or the internal sound collecting device M2) and the internal sound output device SP2C attached to the work machine 100. The manager in the management center MC can listen to the sound generated in the remote control room RC by using, for example, the internal sound collecting device M2E and the internal sound output device SP2C attached to the remote control room RC. Further, the manager in the management center MC can transmit his/her voice to the worker WK around the work machine 100 by using, for example, the internal sound collecting device M2C and the external sound output device SP1 attached to the work machine 100. The manager in the management center MC can transmit his/her voice to the operator OP of the work machine 100 by using, for example, the internal sound collecting device M2C and the internal sound output device SP2 attached to the work machine 100. The manager in the management center MC can transmit his/her voice to the remote operator RO in the remote control room RC by using, for example, the internal sound collecting device M2C and the internal sound output device SP2E attached to the remote control room RC.

### <Functions>

In the above-described embodiment, the output, from the internal sound output device SP2, of the sound collected by the external sound collecting device M1 is limited according to the detection result of the object existing around the work machine 100. By limiting the output of the sound generated from the object from the internal sound output device SP2 according to the detection result of the object, the quietness near the driving seat is improved.

Further, when a plurality of external sound collecting devices M1 are provided, the controller 30 limits the output, from the internal sound output device SP2, of the sound collected by the external sound collecting device M1 provided in the direction where the object exists, among the plurality of external sound collecting devices M1, and outputs the sound collected by the other external sound collecting devices M1 from the internal sound output device SP2, so that the operator of the work machine 100 can hear the speech of the person who exists around the work machine 100 without being obstructed by the sound generated by the object.

Thus, the preferred embodiments and modified examples of the present disclosure have been explained. However, the invention of the present disclosure is not limited to the above-described embodiments. Various modifications, substitutions, etc., can be applied to the above-described embodiments without departing from the scope of the invention of the present disclosure. Each of the features described with reference to the above-described embodiments may be appropriately combined as long as they are not technically inconsistent. Additionally, the modifications are included in the scope of the invention.

What is claimed is:

1. A work machine comprising:
a lower traveling body;
an upper turning body mounted on the lower traveling body so as to freely turn;
a driving room provided in the upper turning body;
an external sound collecting device arranged outside the driving room;
an internal sound output device arranged inside the driving room; and
a control device configured to limit output, from the internal sound output device, of sound collected by the external sound collecting device, according to a detection result of an object existing around the work machine.

2. The work machine according to claim 1, wherein the control device limits the output from the internal sound output device based on whether the sound collected by the external sound collecting device includes a predetermined sound emitted from the object.

3. The work machine according to claim 1, wherein
a plurality of the external sound collecting devices are provided, and
the control device limits the output, from the internal sound output device, of the sound collected by the external sound collecting device provided in a direction in which the object exists, among the plurality of external sound collecting devices.

4. The work machine according to claim 3, wherein the control device detects the direction in which the object exists based on any one or more of the sound collected by each of the plurality of external sound collecting devices, position information of the object and the work machine, image information captured by an imaging device provided to the work machine, and the detection result of the object obtained by an object detection device provided in the work machine.

5. The work machine according to claim 1, further comprising:
an internal sound collecting device arranged inside the driving room; and
an external sound output device arranged outside the driving room, wherein
the control device is capable of controlling output, from the internal sound output device, of sound collected by the external sound collecting device, and is capable of controlling output, from the external sound output device, of sound collected by the internal sound collecting device.

6. The work machine according to claim 5, wherein the control device switches between controlling the output, from the external sound output device, of the sound collected by the internal sound collecting device and performing control to limit the output, from the internal sound output device, of the sound collected by the external sound collecting device, according to a first operation.

7. The work machine according to claim 1, wherein the control device stops the output of the sound from the internal sound output device or increases a gain of a noise canceling function for the sound output from the internal sound output device as compared to that before detecting the object, to limit the output of the sound from the internal sound output device.

8. The work machine according to claim 1, wherein the control device receives, from the object, operation information indicating an operation situation of the object, and limits the output, from the internal sound output device, of the sound collected by the external sound collecting device, based on the operation information.

9. The work machine according to claim 1, wherein the control device receives, from the object, a sound signal acquired by the object, and outputs, from the internal sound output device, a sound indicated by the sound signal.

10. The work machine according to claim 1, wherein the control device provides a report based on limitation of the output of the sound.

11. A control system for a work machine comprising:
the work machine including:
a lower traveling body;
an upper turning body mounted on the lower traveling body so as to freely turn;
a driving room provided in the upper turning body; and
an external sound collecting device arranged outside the driving room;
a sound output device arranged around an operation seat for operating the work machine; and
a control device configured to limit output, from the sound output device, of sound collected by the external sound collecting device, according to a detection result of an object existing around the work machine.
